(19) United States
(12) Patent Application Publication
(10) Pub. No.: US 2019/0168967 A1
(43) Pub. Date: Jun. 6, 2019

(54) PLANE STORAGE AND TRANSPORTATION UNIT OF A STEREOSCOPIC WAREHOUSE WITH FOUR-DIRECTION MOVABLE GOODS ALLOCATIONS

(71) Applicant: Shengxi JIN, Changchun (CN)

(72) Inventor: Shengxi JIN, Changchun (CN)

(21) Appl. No.: 16/190,096

(22) Filed: Nov. 13, 2018

(30) Foreign Application Priority Data
Dec. 3, 2017 (CN) 201711255716.6

(51) Int. Cl. B65G 1/137; B65G 1/133; B65G 1/127

(52) U.S. Cl. CPC B65G 1/1373; B65G 1/133; E04H 6/22; B65G 2201/0294; B65G 1/127

(57) ABSTRACT

A plane storage and transportation unit of a stereoscopic warehouse with four-direction movable goods allocations, wherein: groups of tracks are disposed on the X and Y axes vertical to the rectangular coordinate system; a goods carrier or a device for moving it is run on tracks and moves by power systems; at each intersection of tracks, the track and advancing system of the goods carrier or the device for moving it enable an advancing direction of the goods carrier to be transformed between the tracks; or a unit power roller conveyor or power conveyor belt tightly provided with rotation direction transfers and moves goods. It is used on the basic plane component of storage and transportation of stereoscopic warehouse or parking garage; library collections, archives archiving, museum collections, and storage of goods; built-in cabinet with partition wall in smart home; museum collections, artworks, jewelry, clothing and other display systems.

### BACKGROUND OF THE INVENTION

### 1. Field of the Invention

The invention relates to the storage field such as stereoscopic warehouse and stereoscopic parking and the filed such as furniture storage and home improvement, and in particular, to a plane storage and transportation unit of a stereoscopic warehouse with four-direction movable goods allocations.

### 2. Description of the Related Art

The prior stereoscopic warehouse can be divided into the unit-goods-type stereoscopic warehouse, the through-type stereoscopic warehouse, the automated cabinet-style stereoscopic warehouse, the stripe shelf stereoscopic warehouse, etc., according to the shelf structure thereof. According to the type of machinery for loading goods in the stereoscopic warehouse, it can be divided into the shelf forklift stereoscopic warehouse, roadway stacker stereoscopic warehouse, etc. Regardless of the form, the stereoscopic warehouse has a common shortcoming: the goods allocation itself cannot be moved. The goods access depends on the forklift or the stacker that must operate in the direction of the goods entering and leaving the goods allocation. This limits the depth of the arrangement of the goods allocation: the depth of the goods allocation can only be two. The standard model thus arranged is that the two goods allocations are arranged back to back in a storage unit, and a channel is provided between each two storage units for the forklift or the stacker to access the goods. Even if some stereoscopic warehouses can be moved, the moving direction is only two-way movement, and it is impossible to move in four directions in each plane. The stereoscopic parking garage has lifting and traversing type, vertical circulation type, simple lifting type, vertical lifting type, plane moving type, roadway stacking type, multi-layer circulation type, horizontal circulation type, and car lifting type. Regardless of the form, the stereoscopic parking garage has a common shortcoming: the moving direction of the parking space is mostly two. At most, the local parking space can realize three-way moving in the plane. It is impossible to move in four directions for each parking space. The above characteristics cause the low space utilization rate of the existing stereoscopic warehouse and parking garage.

The prior home storage facilities, regardless of cabinets, bookcases, lockers, and sundries cabinets, are visible and convenient for accessing goods, and are divided into numerous small storage spaces, resulting in numerous openings for the cabinet to access goods. It is necessary to leave an operation channel for accessing goods on the opening side of the cabinet, which is the same as the setting of the prior stereoscopic warehouse, and the space utilization efficiency is low. On the other hand, there are many openings for the cabinet to access goods, which need to be covered by the corresponding cabinet doors. Not only the decorative effect is poor, but the sealing is not good, dust is easy to be accumulated, and the anti-theft function is weak. Space that is higher than two meters basically cannot be used as storage space, because manual access is more difficult, and assist climbing tools are required; the space utilization rate is low, dust is easy to be accumulated at the top of the cabinet, and is not easy to be cleaned. Foremost, everyone has the experience that you cannot find something you want; it is difficult for the prior furniture storage to store files intelligently, and the files cannot be accessed automatically.

### SUMMARY OF THE INVENTION

The invention aims at providing a plane storage and transportation unit of a stereoscopic warehouse with four-direction movable goods allocations, so as to solve the issues set forth in the background art described above.

To achieve the above objective, the invention provides a technical solution as follows:

an X axis in a spatial rectangular plane coordinate system is vertical to a Y axis therein, N groups of single track or double track A is disposed along the X axis, and M groups of single track or double track B is disposed along the Y axis; a goods carrier or a device for moving the goods carrier is run on the tracks A and B; the goods carrier or the device for moving the goods carrier is equipped with an advancing system matched with the track, and moves by depending on a power system thereof or under the action of an external power system; at each intersection of the track A and the track B, the track and the advancing system of the goods carrier or the device for moving the goods carrier enable an advancing direction of the goods carrier to be transformed between the track A and the track B;

or the goods carrier is combined with the device for moving the goods carrier in the system, and a unit power roller conveyor or a power conveyor belt which is tightly provided and has a rotation direction transfers and moves the goods.

The X axis in the spatial rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable or beeline-shaped two-direction track section D is arranged at each intersection of an extension line of the track A and an extension line of the track B; the cross-shaped four-direction rotatable or beeline-shaped two-direction track section D combining into a complete communication track with the track A combines into a complete communication track with the track B after rotating 90°, and gets back in position after reversely rotating 90° to combine into a complete communication track with the track B; the goods carrier or the device for moving the goods carrier is run on the tracks A and B; advancing wheels matched with the track are arranged under the goods carrier or the device for moving the goods carrier, and are driven by the cross-shaped four-direction rotatable or beeline-shaped two-direction track section D for rotation; and the goods carrier moves by depending on the power system thereof or under the action of the external power system;

the X axis in the spatial rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable or beeline-shaped two-direction track section D is arranged at each intersection of an extension line of the track A and an extension line of the track B; the advancing wheels matched with the track are arranged below the goods carrier; the cross-shaped four-direction rotatable or beeline-shaped two-direction track section D combining into a complete communication track with the track A combines into a complete communication track with the track B after rotating 90°, and meanwhile, drives the advancing wheels of the goods carrier thereon to rotate 90°; the cross-shaped four-direction rotatable or beeline-shaped two-direction track section D combining into a complete communication track with the track B gets back in position after reversely rotating 90° to combine into a complete communication track with the track A, and meanwhile, drives the advancing wheels of the goods carrier thereon to reversely rotate 90°;

a track J is arranged under the track A in a way parallel to the track A; the lever liftable track push-pull machines F1 and F2 which are connected together are arranged on the track J, and under the drive of a motor, levers G1 and G2 on F1 and F2 accurately rotate 90° or reversely rotate 90° successively, and the levers G1 and G2 are extended or withdrawn successively to come into contact with the goods carrier or release the contact; tensioning devices H1 and H2 are arranged at the two ends of the track J respectively, and draglines I of the tensioning devices are respectively connected to the two ends of the lever liftable track push-pull machines along the track J;

a track K is arranged above the goods carrier on the track B in a way parallel to the track B; the lever liftable track push-pull machines are arranged on the track K, and under the drive of the motor, the levers accurately rotate 90° and are extended to come into contact with the goods carrier; the tensioning devices are respectively arranged at the two ends of the track K, and the draglines of the tensioning devices are respectively connected to the two ends of the lever liftable track push-pull machines along the track K;

or, the tracks J and K are arranged above the goods carrier and respectively parallel to the tracks A and B, a track self-propelling lever liftable push-pull machine is arranged on the tracks J and K and has a power action device which moves along the track J or K.

The X axis in the spatial rectangular plane coordinate system is vertical to the Y axis therein, N groups of discontinuous single track or double track A is disposed along the X axis, M groups of discontinuous single track or double track B is disposed along the Y axis, and a four-direction rotatable or beeline-shaped two-direction track section D is arranged at each intersection of an extension line of the track A and an extension line of the track B; the cross-shaped four-direction rotatable or beeline-shaped two-direction track section D combining into a complete communication track with the track A combines into a complete communication track with the track B after rotating 90°; the cross-shaped four-direction rotatable or beeline-shaped two-direction track section D combining into a complete communication track with the track B gets back in position after reversely rotating 90° to combine into a complete communication track with the track A; and a self-propelled transfer robot advancing along the track is arranged on the track below the goods location carrier; or a self-propelled lifting robot advancing along the track is arranged on the track above the goods location carrier.

An X axis in a vertical rectangular plane coordinate system is vertical to a Y axis therein, N groups of discontinuous single track or double track A is disposed along the X axis, M groups of discontinuous single track or double track B is disposed along the Y axis, and a cross-shaped four-direction rotatable or beeline-shaped two-direction track section D is arranged at each intersection of an extension line of the track A and an extension line of the track B; the advancing wheels matched with the track are arranged below the goods carrier; the cross-shaped four-direction rotatable or beeline-shaped two-direction track section D combining into a complete communication track with the track A combines into a complete communication track with the track B after rotating 90°; the cross-shaped four-direction rotatable or beeline-shaped two-direction track section D combining into a complete communication track with the track B gets back in position after reversely rotating 90° to combine a complete communication track with the track A;

the track J is arranged in front of the goods carrier opposite the track A in a way parallel to the track A, the lever liftable track push-pull machine is arranged on the track J, and under the drive of the motor, the lever accurately rotates and is extended to come into contact with the goods carrier; the tensioning devices are arranged at the two ends of the track J respectively, and the draglines of the tensioning devices are respectively connected to the two ends of the lever liftable track push-pull machine along the track J;

the track K is arranged at the side of the track B in a way parallel to the track B, the lever liftable track push-pull machine is arranged on the track K, and under the drive of the motor, the lever accurately rotates and is extended to be inserted into the lower portion of the goods carrier; tensioning devices are respectively arranged at the two ends of the track K, and the draglines of the tensioning devices are respectively connected to the two ends of the lever liftable track push-pull machine along the track K;

or, a crane is arranged at the top of each group of track B, a lifting ring is arranged below a crane rope, a pair-advancing hook is arranged at the top of each goods carrier, and a lifting ring is arranged at the bottom thereof;

or, the tracks J and K are respectively arranged opposite the goods carrier in a way parallel to the tracks A and B, the track self-propelling lever liftable push-pull machine is arranged on the tracks J and K, and has the power action device enabling the track self-propelling lever liftable push-pull machine to move along the track J or K.

A unit power roller conveyor or a unit power conveying belt rotating platform is arranged on each goods allocation, the X axis in the spatial rectangular plane coordinate system is vertical to the Y axis therein, the unit power roller conveyor or the unit power conveying belt rotating platform along the X axis is taken as an N line, and the unit power roller conveyor or the unit power conveying belt rotating platform along the Y axis is taken as an M column; a conveying direction is the Y axis after the unit power roller conveyor or the unit power conveying belt rotating platform in the X axis rotates 90°, and restores to the X axis after the unit power roller conveyor or the unit power conveying belt rotating platform reversely rotates 90°; and the unit power roller conveyor or the unit power conveying belt rotating platform has forward and backward conveying directions.

The track section is set into a crisscross shape or beeline shape, the motor is arranged below the track, and under the drive of the motor, the cross-shaped four-direction rotatable or beeline-shaped two-direction track section accurately rotates 90° or reversely rotates 90°, and drives the advancing wheels of the goods carrier or the transfer robot, the lifting robot, the track lever liftable push-pull machine and the track self-propelling lever liftable push-pull machine to rotate;

or, chambers to rotate the advancing wheels of the goods carrier or the transfer robot, the lifting robot, the track lever liftable push-pull machine and the track self-propelling lever liftable push-pull machine are arranged in the cross-shaped four-direction track section formed by track intersection.

The lever liftable track push-pull machine is equipped with the motor, and under the drive of the motor, the lever accurately rotates or reversely rotates, and comes into contact with the goods carrier and release the contact with the same respectively; the tensioning devices are arranged at the two ends of the track respectively, the draglines of the tensioning devices are respectively connected to the two ends of the lever liftable track push-pull machine along the track, and the lever liftable track push-pull machine is dragged to move along the track through the coordination of forward and backward pulling of the tensioning device 1 and pushing of the tensioning device 2 in the backward and forward direction, wherein the tensioning device 1 and the tensioning device 2 are arranged at the two ends of the track;

or, the lever liftable track push-pull machine is equipped with the power action device, which has a self-action function and is called as the track self-propelling lever liftable push-pull machine;

and the lever liftable track push-pull machine rotates under the drive of the motor, to meet the needs of different push-pull angles.

The pair-advancing hook is equipped with a pair of horizontal booms arranged oppositely, and the pair of booms moves oppositely or away under the drive of the motor, to be respectively inserted into or separated from the lifting ring to keep the locking and unlocking with the lifting ring.

The goods carrier or the device for moving the goods carrier is equipped with four-direction lifting advancing wheels, and when the goods carrier is to be advanced on the track A, the advancing wheels W1 and W2 of the four-direction lifting advancing wheels of the goods carrier in the track A direction are descended to come into contact with the track A, and subsequently, the advancing wheels X1 and X2 in the track B direction are ascended to be out of contact with the track B; when the goods carrier is to be advanced on the track B, the advancing wheels X1 and X2 of the four-direction lifting advancing wheels of the goods carrier in the track B are descended to come into contact with the track B, and subsequently, the advancing wheels W1 and W2 in the track A are ascended to be out of contact with the track A; and therefore, the switch of a moving direction of the goods carrier between the track A and the track B is realized, and a moveable track passage in four directions, i.e. two directions of the track A and the track B respectively, is built.

### BRIEF DESCRIPTION OF THE DRAWINGS

FIG. 1 is the top view illustrating the embodiment 1;

FIG. 2 is the bottom view illustrating the embodiment 1;

FIG. 3 is the front view illustrating the embodiment 1;

FIG. 4 is the side view illustrating the embodiment 1;

FIG. 5 is the stereoscopic view illustrating the embodiment 1, the schematic diagram illustrating the lever liftable track push-pull machines F1 and F2, and the schematic diagram illustrating the cross-shaped four-direction rotatable track section D;

FIG. 6 is the top view illustrating the embodiment 2;

FIG. 7 is the bottom view illustrating the embodiment 2;

FIG. 8 is the front view illustrating the embodiment 2;

FIG. 9 is the side view illustrating the embodiment 2;

FIG. 10 is the stereoscopic view illustrating the embodiment 2, and the schematic diagram illustrating the cross-shaped four-direction rotatable track section D;

FIG. 11 is the top view illustrating the embodiment 3;

FIG. 12 is the bottom view illustrating the embodiment 3;

FIG. 13 is the front view illustrating the embodiment 3;

FIG. 14 is the side view illustrating the embodiment 3;

FIG. 15 is the stereoscopic view illustrating the embodiment 3, and the schematic diagram illustrating the transfer robot;

FIG. 16 is the top view illustrating the embodiment 4;

FIG. 17 is the bottom view illustrating the embodiment 4;

FIG. 18 is the front view illustrating the embodiment 4;

FIG. 19 is the side view illustrating the embodiment 4;

FIG. 20 is the stereoscopic view illustrating the embodiment 4, the schematic diagram illustrating the lifting robot, and the schematic diagram illustrating the cross-shaped four-direction rotatable track section D;

FIG. 21 is the front view illustrating the embodiment 5;

FIG. 22 is the rear view illustrating the embodiment 5;

FIG. 23 is the side view illustrating the embodiment 5, and the schematic diagram illustrating the advancing wheels and track of the goods carrier;

FIG. 24 is the side view illustrating the embodiment 6;

FIG. 25 is the top view illustrating the embodiment 5;

FIG. 26 is the top view illustrating the embodiment 6;

FIG. 27 is the stereoscopic view illustrating the embodiment 5, and the schematic diagram illustrating the lever liftable track push-pull machine;

FIG. 28 is the front view illustrating the embodiment 6;

FIG. 29 is the rear view illustrating the embodiment 6;

FIG. 30 is the stereoscopic view illustrating the embodiment 6, and the schematic diagram illustrating the pair-advancing hoisting and linking system;

FIG. 31 is the front view illustrating the embodiment 7;

FIG. 32 is the rear view illustrating the embodiment 7;

FIG. 33 is the side view illustrating the embodiment 7;

FIG. 34 is the top view illustrating the embodiment 7;

FIG. 35 is the schematic diagram illustrating the chamber Y to rotate the advancing wheels of the goods carrier or the device for moving the goods carrier;

FIG. 36 is the stereoscopic view illustrating the four-direction lifting advancing wheels in embodiment 9;

FIG. 37 is the stereoscopic view illustrating the embodiment 7;

FIG. 38 is the top view illustrating the embodiment 8;

FIG. 39 is the sectional view illustrating the Z-Z in embodiment 8;

### DETAILED DESCRIPTION OF THE PREFERRED EMBODIMENTS

The technical solutions of the embodiments will be described clearly and completely with reference to the drawings of the invention hereinafter.

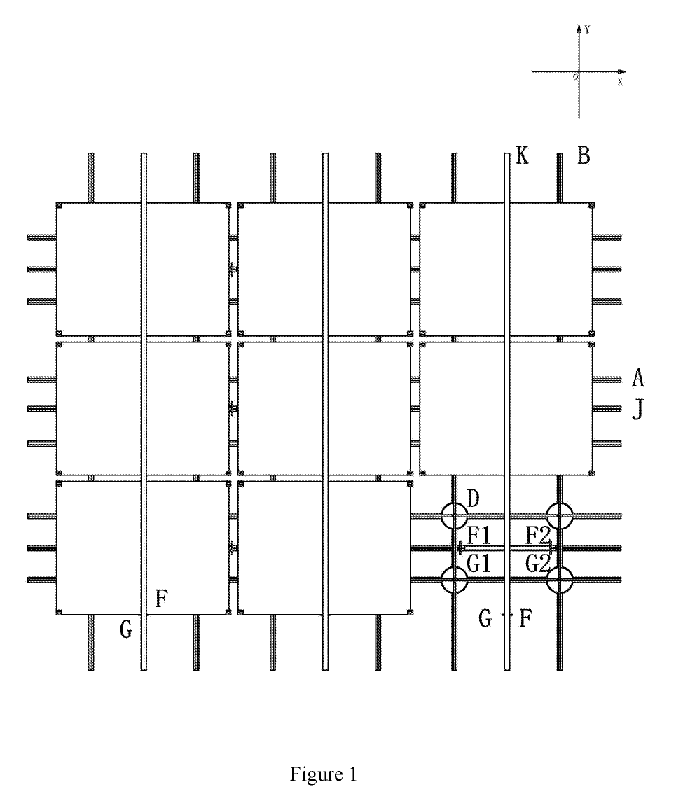

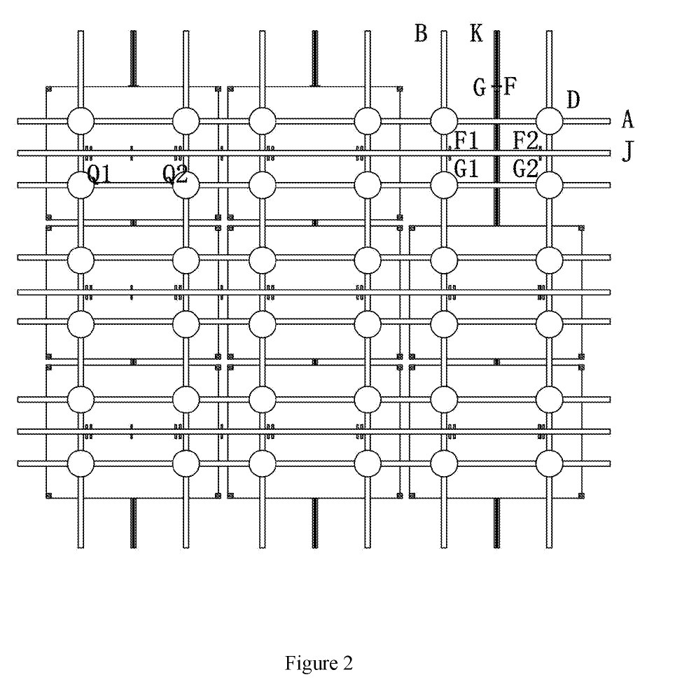

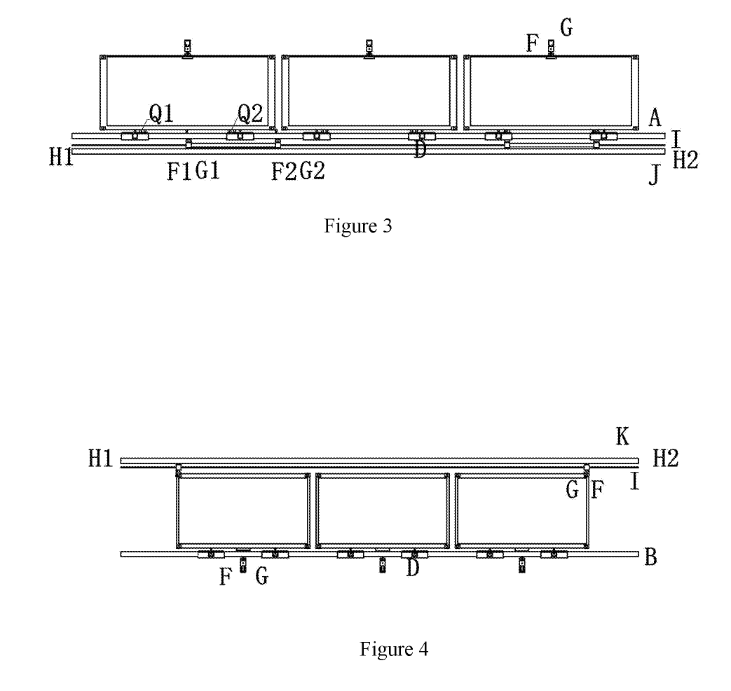

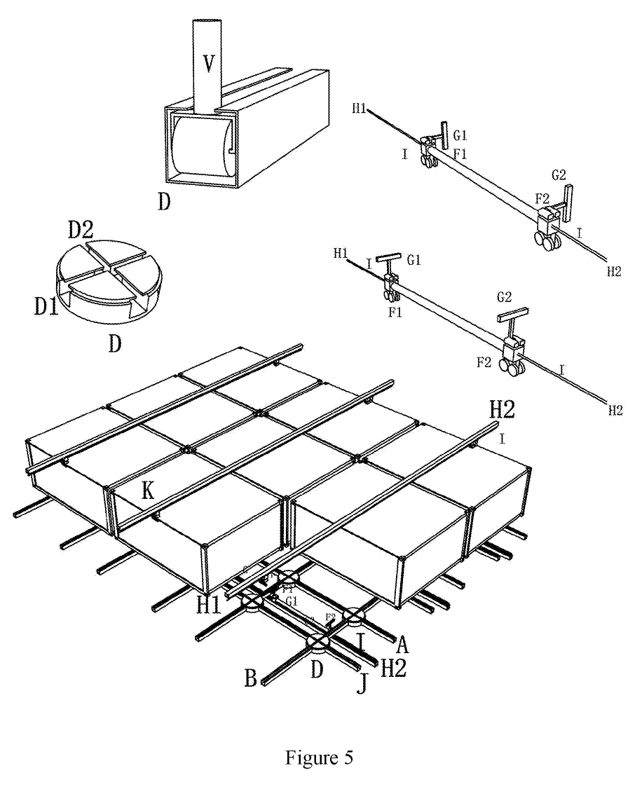

Embodiment 1: see FIG. 1-5. An X axis in a horizontal rectangular plane coordinate system is vertical to a Y axis therein, N groups of discontinuous single track or double track A is disposed along the X axis, M groups of discontinuous single track or double track B is disposed along the Y axis, and a cross-shaped four-direction rotatable track section D (crisscrossed, comprising D1 and D2, see FIG. 5) is arranged at each intersection of an extension line of the track A and an extension line of the track B; the advancing wheels matched with the track are arranged below the goods carrier; the cross-shaped four-direction rotatable track section D (track section D1 of the advancing wheels under the goods carrier) combining into a complete communication track with the track A combines into a complete communication track with the track B after rotating 90°, and meanwhile, drives the advancing wheels of the goods carrier thereon to rotate 90°; the cross-shaped four-direction rotatable track section D (track section D1 of the advancing wheels under the goods carrier) combining into a complete communication track with the track B gets back in position after reversely rotating 90° to combine into a complete communication track with the track A, and meanwhile, drives the advancing wheels of the goods carrier thereon to reversely rotate 90°.

The cross-shaped four-direction rotatable track section D is equipped with the motor which can be accurately rotated 90° or reversely rotated 90°, and drives the advancing wheels of the goods carrier to rotate 90° or reversely rotate 90°; and therefore, the switch of a moving direction of the goods carrier between the track A and the track B is realized, and a moveable track passage in four directions, i.e. two directions of the track A and the track B respectively, is built. Or, the track A and the track B are set continuously, and the chamber Y to rotate the advancing wheels of the goods carrier is arranged at each intersection of the track A and the track B, see FIG. 35; and therefore, the switch of a moving direction of the goods carrier between the track A and the track B is realized.

A track J is arranged under the track A in a way parallel to the track A; lever liftable track push-pull machines F1 and F2 which are connected together are arranged on the track J, and under the drive of a motor, the lever G1 on F1 accurately rotates 90° and is ascended to come into contact with the lever push-pull goods carrier device Q1 arranged below the goods carrier (the lever G2 on the lever liftable track push-pull machine F2 can also lift up to come into contact with Q2). The distance between F1 and F2 is equal to the distance between Q1 and Q2. Tensioning devices H1 and H2 are arranged at the two ends of the track J respectively, and draglines I of the tensioning devices are respectively connected to the two ends of the lever liftable track push-pull machines F1 and F2 along the track J; and the lever liftable track push-pull machines F1 and F2 are dragged to move along the track J through the coordination of forward and backward pulling of the tensioning device H1 and pushing of the tensioning device H2 in the backward and forward direction, wherein the tensioning device H1 and the tensioning device H2 are arranged at the two ends of the track; it is also possible to use fluid transmission such as liquid pressure power, mechanical transmission such as gear chain, electric transmission such as linear motor, electromagnetic transmission, etc. The lever G1 is ascended, comes into contact with Q1, and drives the goods carrier to move along the track A till the lever push-pull goods carrier device Q2 arranged below the goods carrier crosses over the two tracks B, then the lever G2 on the lever liftable track push-pull machine F2 accurately rotates 90° and is ascended to come into contact with the lever push-pull goods carrier device Q2 arranged below the goods carrier, pushing the movement of the goods carrier; and meanwhile, the lever G1 on the lever liftable track push-pull machine F1 reversely rotates 90° and is descended to be out of contact with the goods carrier; the lever liftable track push-pull machine F2 pushes the goods carrier till the advancing wheels under the goods carrier accurately move to the four (under the situation of double-track) cross-shaped four-direction track section D of the next goods allocation and stops. The lever liftable track push-pull machine can be provided with multiple, or other units can be supplemented to efficiently move the goods carrier.

A track K is arranged above the goods carrier on the track B in a way parallel to the track B; the lever liftable track push-pull machine F is arranged on the track K, and under the drive of the motor, the levers G accurately rotate 90° and are descended to come into contact with the goods carrier; tensioning devices H1 and H2 are arranged at the two ends of the track K respectively, and draglines I of the tensioning devices are respectively connected to the two ends of the lever liftable track push-pull machines F along the track K; and the lever liftable track push-pull machines F are dragged to move along the track K through the coordination of forward and backward pulling of the tensioning device H1 and pushing of the tensioning device H2 in the backward and forward direction, wherein the tensioning device H1 and the tensioning device H2 are arranged at the two ends of the track (it is also possible to use fluid transmission such as liquid pressure power, mechanical transmission such as gear chain, electric transmission such as linear motor, electromagnetic transmission, etc.), to drives the goods carrier to move along the track B till the advancing wheels under the goods carrier accurately move to the four (under the situation of double-track) cross-shaped four-direction rotatable track section D of the to-be moved goods allocation and stops. The lever liftable track push-pull machine can be provided with multiple, or other units can be supplemented to efficiently move the goods carrier.

When there is at least one goods allocation free and there is no goods carrier, each goods carrier can be moved to any goods allocation positions by transposition with adjacent vacant goods allocations.

When the plane where the plane storage and transportation unit of a stereoscopic warehouse is located is a non-horizontal plane that is at an angle to the horizontal plane, the basic arrangement of the embodiment is the same as the plane where the plane storage and transportation unit of a stereoscopic warehouse is horizontal; in order to overcome the effect of gravity on the goods carrier, after the goods carrier is in place, the lever of the lever liftable track push-pull machine still comes into contact with the goods carrier to prevent it from falling; the four-direction rotatable track section D is rotated, to make the direction of the advancing wheels under the goods carrier horizontal, so as to lock the goods carrier to prevent it from falling. When the goods carrier is to be moved, the lever of the lever liftable track push-pull machine firstly contacts the goods carrier to prevent it from falling, and then the four-direction rotatable track section D is rotated. In addition, auxiliary goods allocation locking devices for goods carriers can be added.

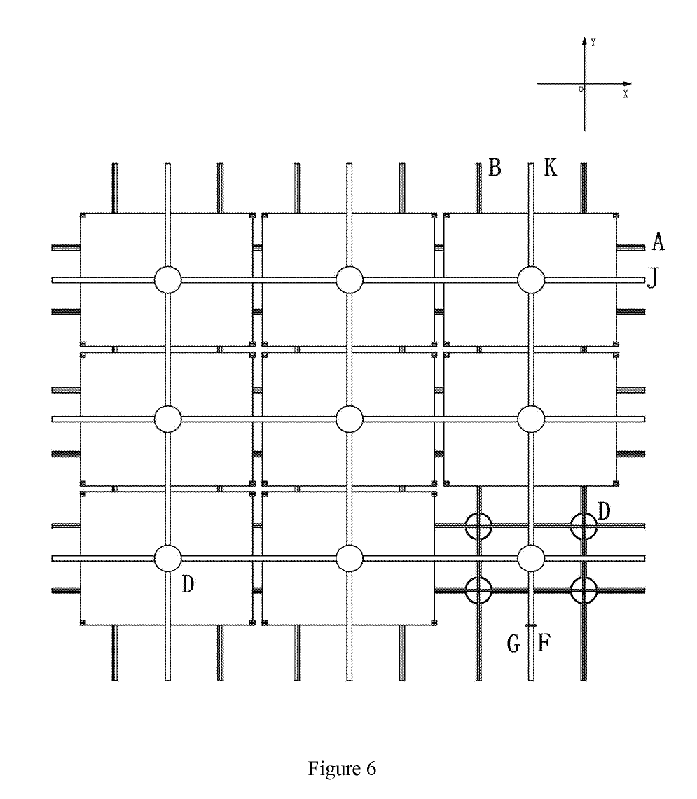

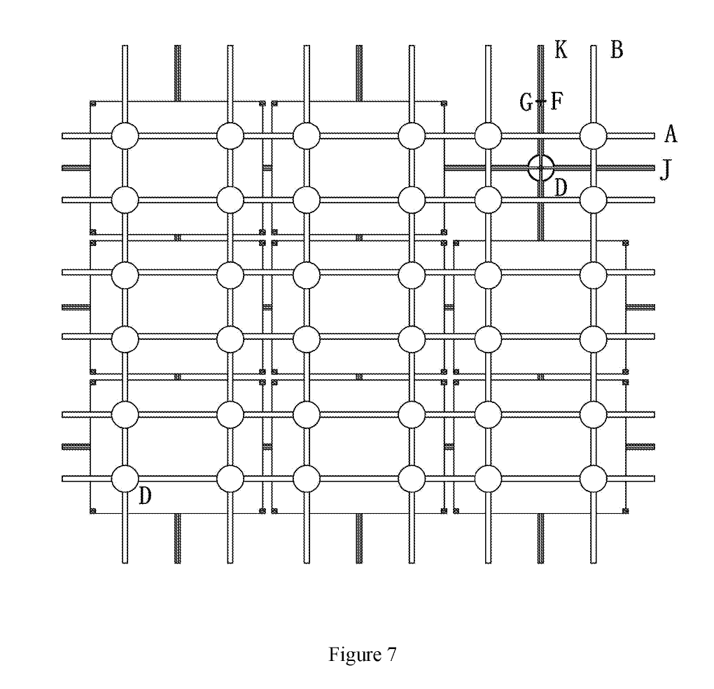

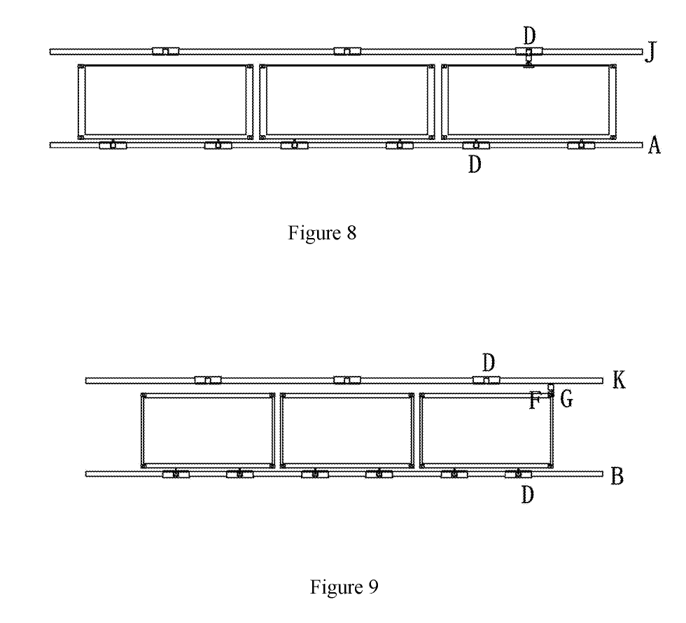

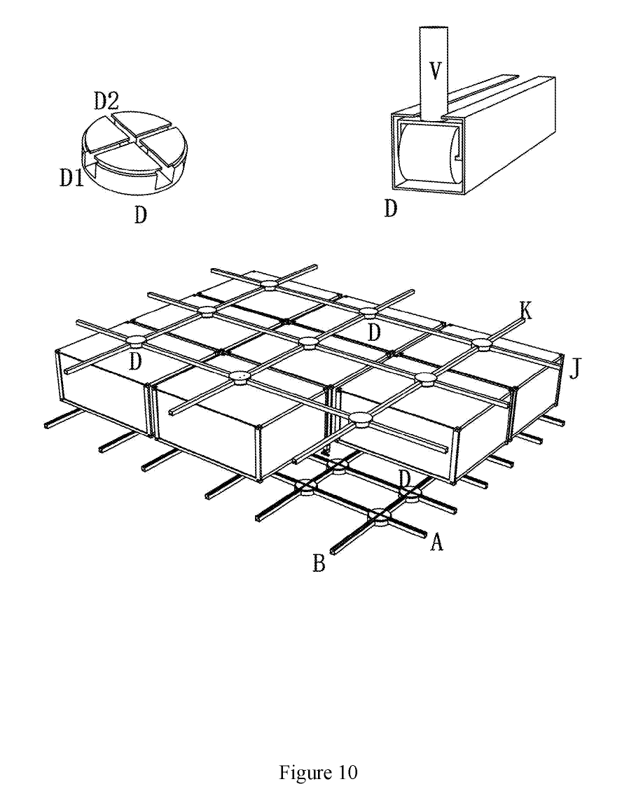

Embodiment 2: see FIG. 6-10. The X axis in the horizontal rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable track section D (crisscrossed, comprising D1 and D2, see FIG. 10) is arranged at each intersection of an extension line of the track A and an extension line of the track B; the advancing wheels matched with the track are arranged below the goods carrier; the cross-shaped four-direction rotatable track section D (track section D1 of the advancing wheels under the goods carrier) combining into a complete communication track with the track A combines into a complete communication track with the track B after rotating 90°, and meanwhile, drives the advancing wheels of the goods carrier thereon to rotate 90°; the cross-shaped four-direction rotatable track section D (track section D1 of the advancing wheels under the goods carrier) combining into a complete communication track with the track B gets back in position after reversely rotating 90° to combine into a complete communication track with the track A, and meanwhile, drives the advancing wheels of the goods carrier thereon to reversely rotate 90°.

The tracks J and K are respectively arranged above the goods carrier in a way parallel to the tracks A and B, the track self-propelling lever liftable push-pull machine F is arranged on the tracks J and K, and under the drive of the motor, the levers G of the lever liftable track push-pull machines F accurately rotate 90° and are ascended to come into contact with the goods carrier; the levers G on the lever liftable track push-pull machines F reversely rotate 90° and are descended to be out of contact with the goods carrier. The track self-propelling lever liftable push-pull machines F have a power action device (e.g. fluid transmission such as liquid pressure power, mechanical transmission such as gear chain, electric transmission such as linear motor, electromagnetic transmission, etc.) which moves the track self-propelling lever liftable push-pull machines F along the track J or K; when the levers G come into contact with the goods carrier, the lever liftable track push-pull machines F push the goods carrier to move along the track A or B, till the advancing wheels under the goods carrier accurately move to the four (under the situation of double-track) cross-shaped four-direction track section D of the next goods allocation and stops. The levers G system arranged at the track self-propelling lever liftable push-pull machines F can be rotated 90° in the plane parallel to the horizontal rectangular plane coordinate system (the plane where the X and Y axes are located), the levers G can respectively contact the two adjacent sides of the goods carrier before and after the rotation, to meet the movement of the goods carrier in the two directions of the tracks A and B. The lever liftable track push-pull machine can be provided with multiple, or other units can be supplemented to efficiently move the goods carrier.

The cross-shaped four-direction rotatable track section D is equipped with the motor which can be accurately rotated 90° or reversely rotated 90°, and drives the advancing wheels arranged below the goods carrier to accurately rotate 90° or reversely rotate 90°; and therefore, the switch of a moving direction of the goods carrier between the track A and the track B is realized, and a moveable track passage in four directions, i.e. two directions of the track A and the track B respectively, is built. Or, the track A and the track B, track J and track K are set continuously, and the chamber Y to rotate the advancing wheels of the goods carrier is arranged at each intersection of the track A and the track B, track J and track K, see FIG. 35; and therefore, the switch of a moving direction of the goods carrier and the lever liftable track push-pull machine between the track A and the track B is realized.

When there is at least one goods allocation free and there is no goods carrier, each goods carrier can be moved to any goods allocation positions by transposition with adjacent vacant goods allocations.

When the plane where the plane storage and transportation unit of a stereoscopic warehouse is located is a non-horizontal plane that is at an angle to the horizontal plane, the basic arrangement of the embodiment is the same as the plane where the plane storage and transportation unit of a stereoscopic warehouse is horizontal; in order to overcome the effect of gravity on the goods carrier, after the goods carrier is in place, the lever of the lever liftable track push-pull machine still comes into contact with the goods carrier to prevent it from falling; the four-direction rotatable track section D is rotated, to make the direction of the advancing wheels under the goods carrier horizontal, so as to lock the goods carrier to prevent it from falling. When the goods carrier is to be moved, the lever of the ever liftable track push-pull machine firstly contacts the goods carrier to prevent it from falling, and then moves. In addition, auxiliary goods allocation locking devices for goods carriers can be added.

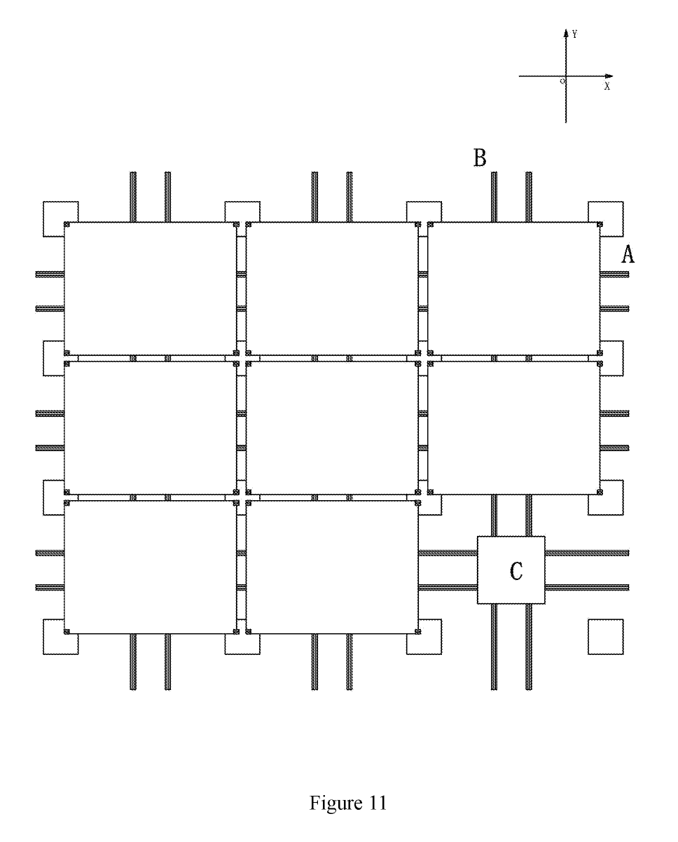

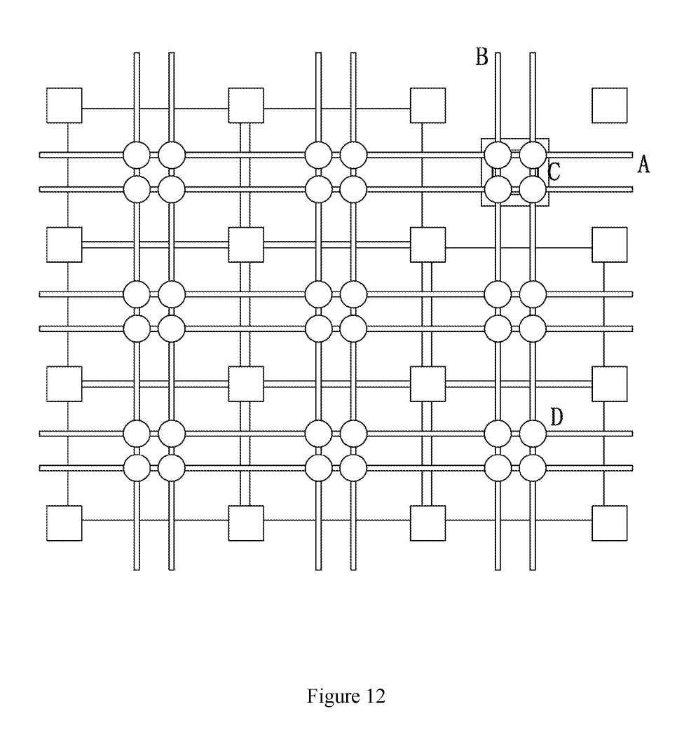

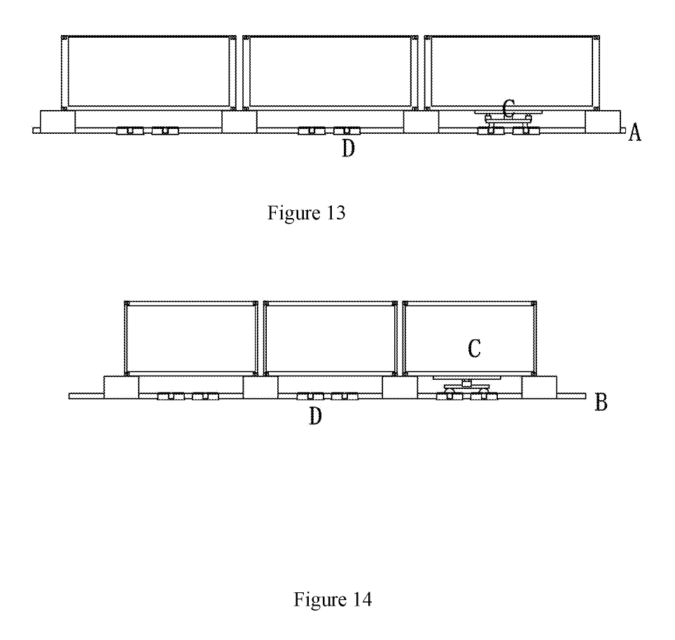

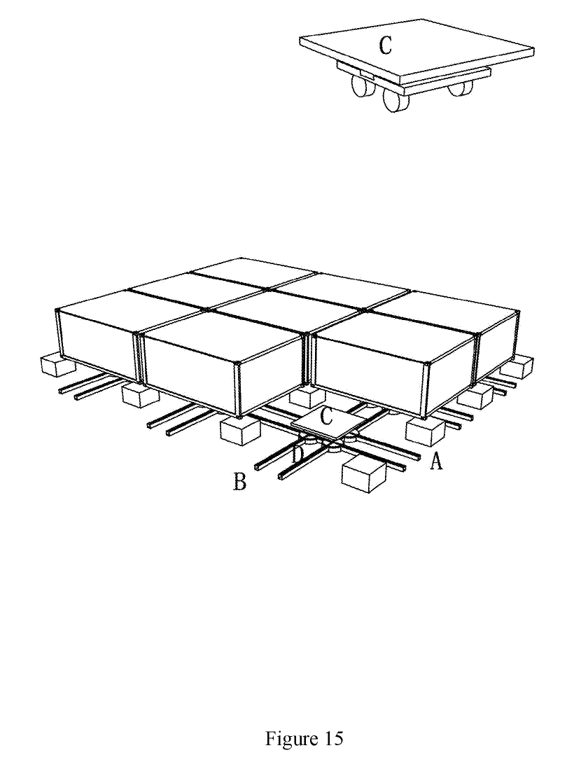

Embodiment 3: see FIG. 11-15. The X axis in the horizontal rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable track section D (crisscrossed, comprising D1 and D2) is arranged at each intersection of an extension line of the track A and an extension line of the track B; the cross-shaped four-direction rotatable track section D (track section D1 of the advancing wheels under the goods carrier) combining into a complete communication track with the track A combines into a complete communication track with the track B after rotating 90°; the cross-shaped four-direction rotatable track section D (track section D1 of the advancing wheels under the goods carrier) combining into a complete communication track with the track B gets back in position after reversely rotating 90° to combine into a complete communication track with the track A; a self-propelled transfer robot C is arranged on the track, see FIG. 15. The self-propelled transfer robot C is equipped with the advancing wheels matched with the track, which can rotate with the cross-shaped four-direction rotatable track section D; and therefore, the switch of a moving direction of the self-propelled transfer robot C between the track A and the track B is realized.

The cross-shaped four-direction rotatable track section D is equipped with the motor which can be accurately rotated 90° or reversely rotated 90°, and drives the advancing wheels of the self-propelled transfer robot to accurately rotate 90° or reversely rotate 90°; and therefore, the switch of a moving direction of the self-propelled transfer robot between the track A and the track B is realized, and a moveable track passage in four directions, i.e. two directions of the track A and the track B respectively, is built. Or, the track A and the track B are set continuously, and the chamber Y to rotate the advancing wheels of the self-propelled transfer robot is arranged at each intersection of the track A and the track B, see FIG. 35; and therefore, the switch of a moving direction of the self-propelled transfer robot between the track A and the track B is realized.

The advancing wheels of the self-propelled transfer robot C accurately move to the four (under the situation of double-track) cross-shaped four-direction rotatable track section D below the to-be moved goods carrier, then the self-propelled transfer robot C is ascended to jack up the goods carrier and move till the advancing wheels of the self-propelled transfer robot accurately move to the four (under the situation of double-track) cross-shaped four-direction rotatable track section D below the to-be moved vacant goods allocation, and the self-propelled transfer robot C is descended to put down the goods carrier. The self-propelled transfer robot C can be provided with multiple, or other units can be supplemented to efficiently move the goods carrier.

When there is at least one goods allocation free and there is no goods carrier, the self-propelled transfer robot C can carry each goods carrier to move to any goods allocation positions by transposition with adjacent vacant goods allocations.

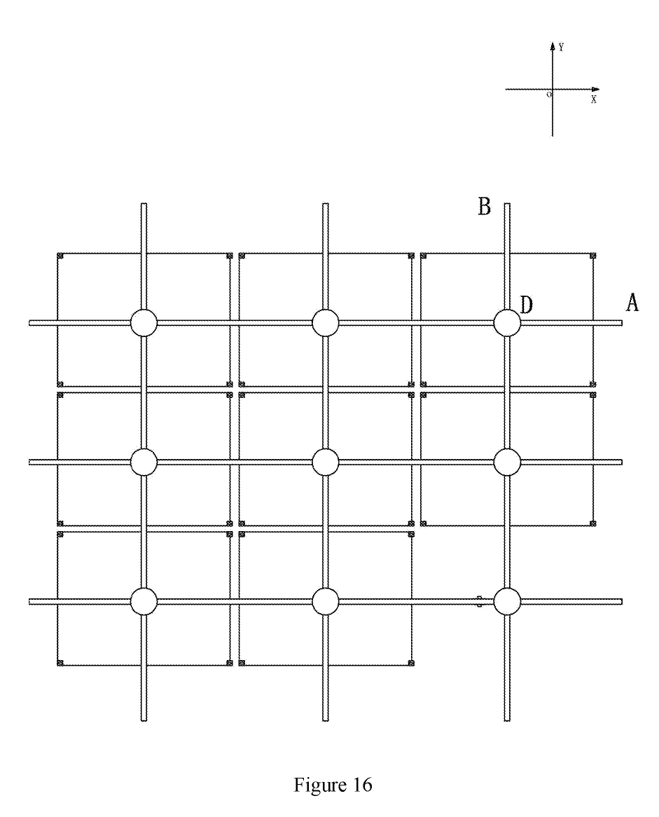

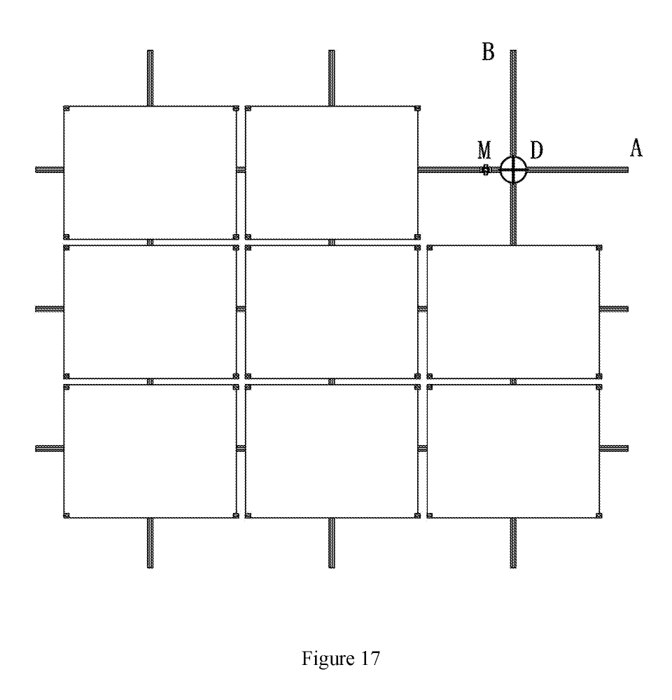

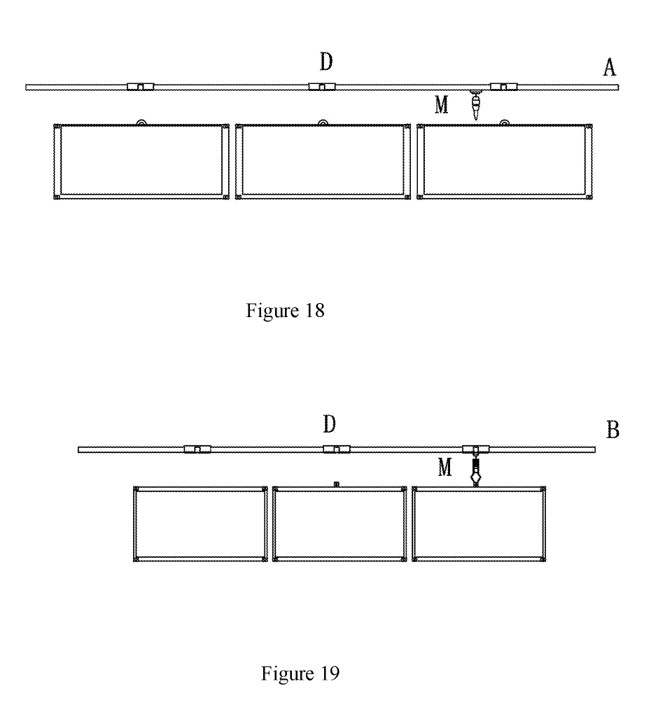

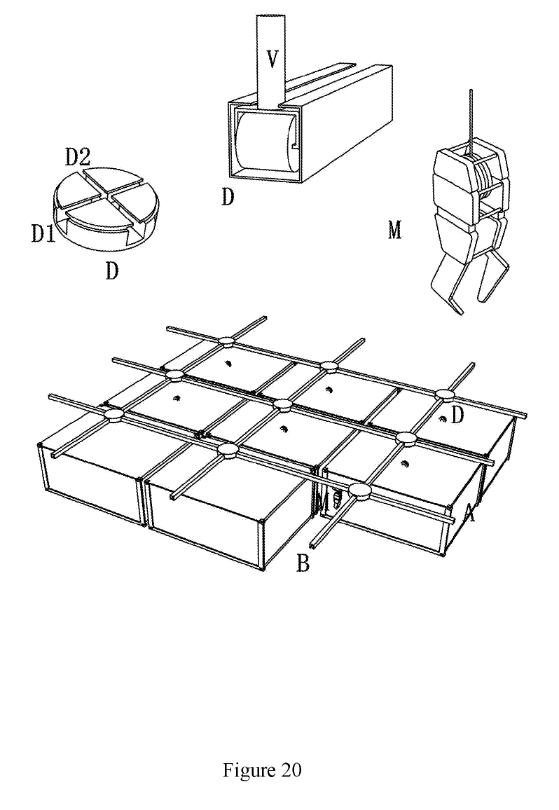

Embodiment 4: see FIG. 16-20. The X axis in the horizontal rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable track section D (crisscrossed, comprising D1 and D2, see FIG. 20) is arranged at each intersection of an extension line of the track A and an extension line of the track B; the cross-shaped four-direction rotatable track section D (track section D1 of the advancing wheels under the goods carrier) combining into a complete communication track with the track A combines into a complete communication track with the track B after rotating 90°; the cross-shaped four-direction rotatable track section D (track section D1 of the advancing wheels under the goods carrier) combining into a complete communication track with the track B gets back in position after reversely rotating 90° to combine into a complete communication track with the track A; a self-propelled lifting robot S is arranged on the track, see FIG. 20. The self-propelled lifting robot S is equipped with the advancing wheels matched with the track, which can rotate with the cross-shaped four-direction rotatable track section D; and therefore, the switch of a moving direction of the self-propelled lifting robot S between the track A and the track B is realized.

The cross-shaped four-direction rotatable track section D is equipped with the motor which can be accurately rotated 90° or reversely rotated 90°, and drives the advancing wheels of the self-propelled lifting robot to accurately rotate 90° or reversely rotate 90°; and therefore, the switch of a moving direction of the self-propelled lifting robot between the track A and the track B is realized, and a moveable track passage in four directions, i.e. two directions of the track A and the track B respectively, is built. Or, the track A and the track B are set continuously, and the chamber Y to rotate the advancing wheels of the self-propelled lifting robot is arranged at each intersection of the track A and the track B, see FIG. 35; and therefore, the switch of a moving direction of the self-propelled lifting robot between the track A and the track B is realized.

The advancing wheels of the self-propelled lifting robot S accurately move to the cross-shaped four-direction rotatable track section D above the to-be moved goods carrier and stops, then the spreader or the manipulator of the self-propelled lifting robot S is descended to jack up the goods carrier and move till the advancing wheels of the self-propelled lifting robot S accurately move to the cross-shaped four-direction rotatable track section D above the to-be moved vacant goods allocation, and the self-propelled lifting robot S puts down the goods carrier, then the spreader or the manipulator is ascended. The self-propelled lifting robot S can be provided with multiple, or other units can be supplemented to efficiently move the goods carrier.

When there is at least one goods allocation free and there is no goods carrier, the self-propelled lifting robot S can carry each goods carrier to move to any goods allocation positions by transposition with adjacent vacant goods allocations.

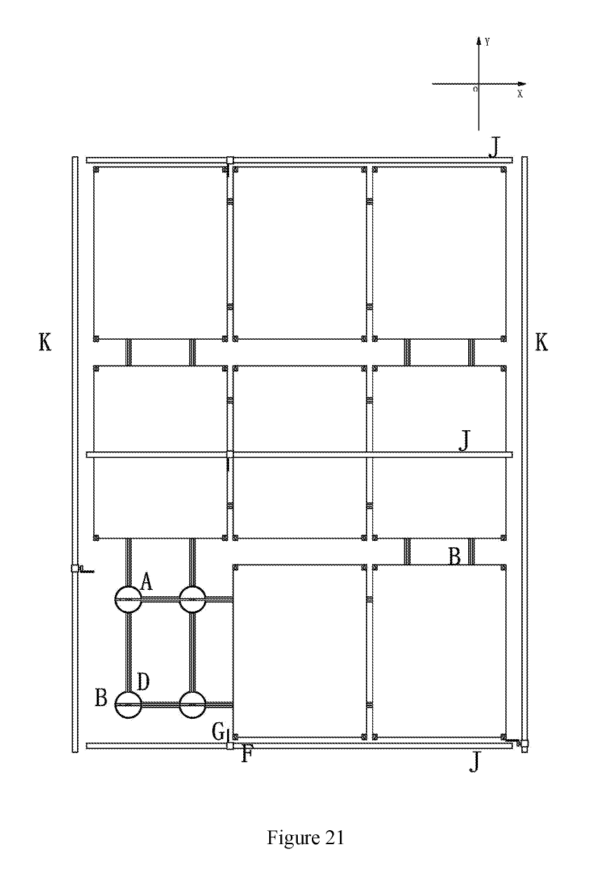

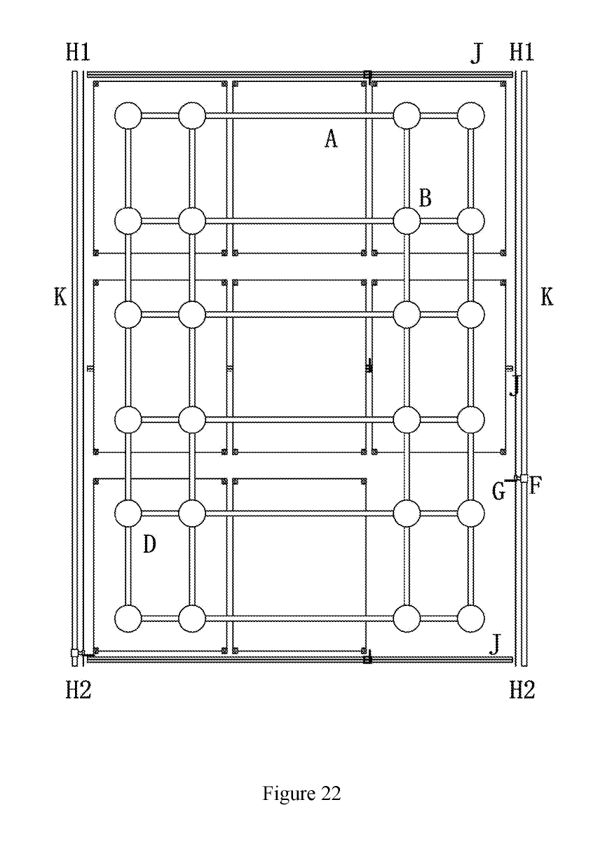

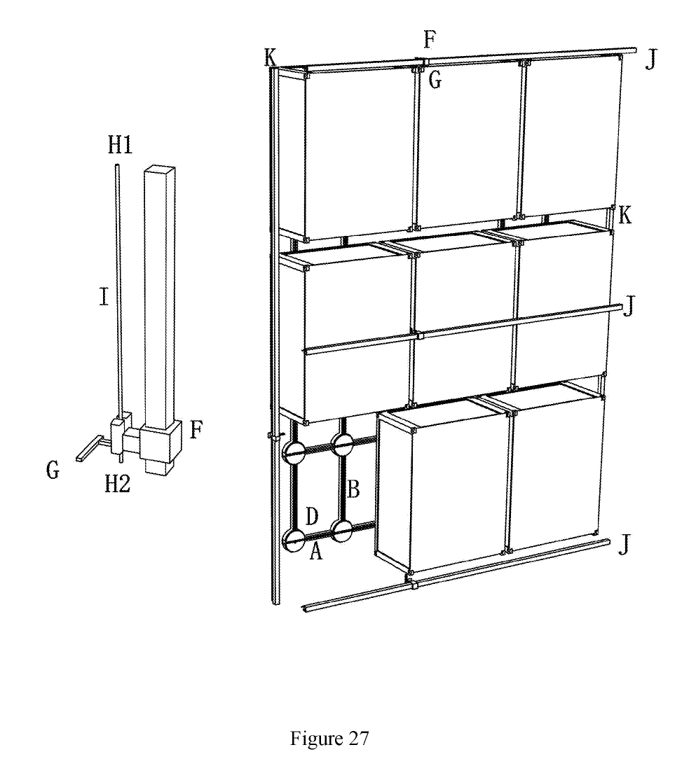

Embodiment 5: see FIGS. 21, 22, 23, 25, and 27. An X axis in a vertical rectangular plane coordinate system is vertical to a Y axis therein, N groups of discontinuous single track or double track A is disposed along the X axis, M groups (2 groups in the illustrated figures) of discontinuous single track or double track B is disposed along the Y axis, and a rotatable beeline-shaped two-direction track section D is arranged at each intersection of an extension line of the track A and an extension line of the track B; the advancing wheels matched with the track are arranged below the goods carrier; the rotatable beeline-shaped two-direction track section D combining into a complete communication track with the track A combines into a complete communication track with the track B after rotating 90°; the rotatable beeline-shaped two-direction track section D combining into a complete communication track with the track B gets back in position after reversely rotating 90° to combine a complete communication track with the track A.

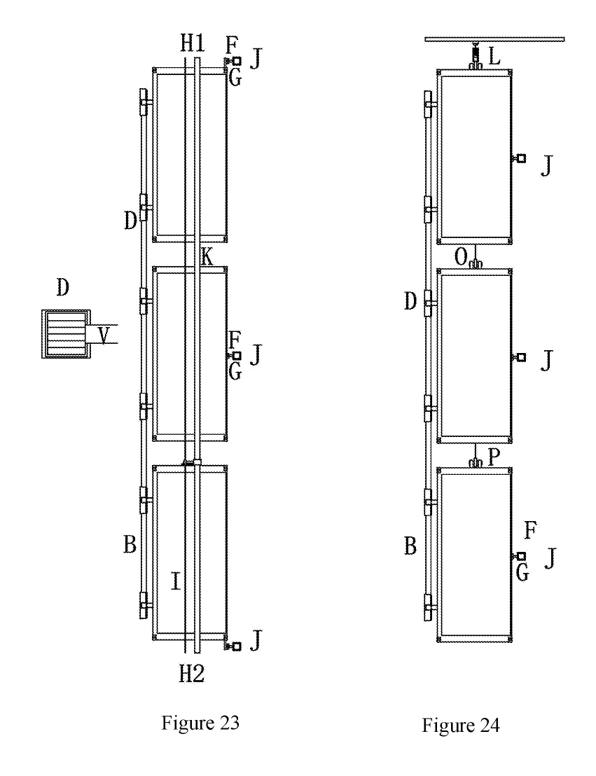

The plane of the advancing wheels matched with the track arranged below the goods carrier is set to be parallel to the X and Y axes in the above-mentioned vertical rectangular plane coordinate system, see FIG. 23 (wherein V is the advancing wheels axis). When the plane of the advancing wheels matched with the track arranged below the goods carrier is set to be vertical to the X and Y axes in the above-mentioned vertical rectangular plane coordinate system, the cross-shaped four-direction rotatable track section D can also be used, see FIGS. 5, 10, and 20 (wherein V is the advancing wheels axis).

The rotatable beeline-shaped two-direction track section D is equipped with the motor which can be accurately rotated 90° or reversely rotated 90°; and therefore, the switch of a moving direction of the goods carrier between the track A and the track B is realized, and a moveable track passage in four directions, i.e. two directions of the track A and the track B respectively, is built.

The track J is arranged in front of the goods carrier opposite the track A in a way parallel to the track A, the lever liftable track push-pull machine F is arranged on the track J, and under the drive of the motor, the lever G accurately rotates and is extended to come into contact with the goods location carrier; tensioning devices H1 and H2 are arranged at the two ends of the track J respectively, and draglines I of the tensioning devices are respectively connected to the two ends of the lever liftable track push-pull machine F along the track J; and the lever liftable track push-pull machine F is dragged to move along the track J through the coordination of forward and backward pulling of the tensioning device H1 and pushing of the tensioning device H2 in the backward and forward direction, wherein the tensioning device H1 and the tensioning device H2 are arranged at the two ends of the track (it is also possible to use fluid transmission such as liquid pressure power, mechanical transmission such as gear chain, electric transmission such as linear motor, electromagnetic transmission, etc.), to drives the goods location carrier to move along the track A till the rear advancing wheels of the goods carrier accurately move to the vacant goods allocation position on the adjacent track A or the four (under the situation of double-track) rotatable beeline-shaped two-direction track section D on the track B. And subsequently, the lever G accurately rotates 90° reversely and is ascended to be out of contact with the goods location carrier. The lever liftable track push-pull machine can be provided with multiple, or other units can be supplemented to efficiently move the goods carrier.

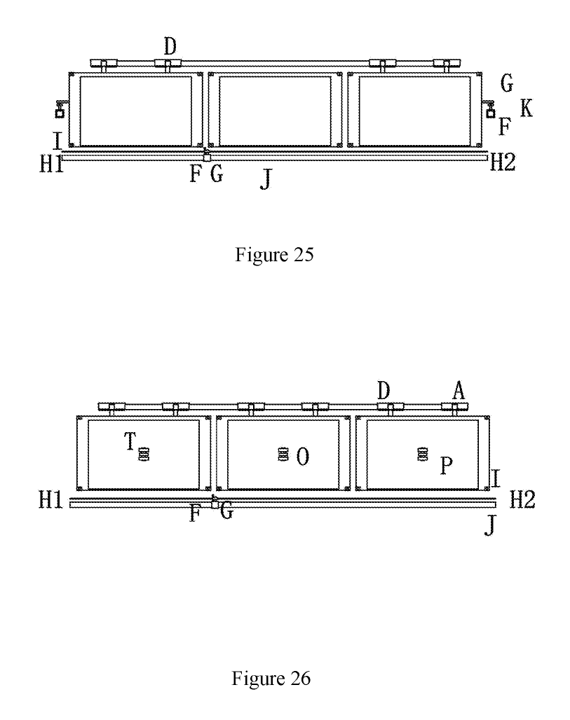

The track K is arranged at the side of the track B in a way parallel to the track B, the lever liftable track push-pull machine F is arranged on the track K, and under the drive of the motor, the lever G accurately rotates and is extended to be inserted into the lower portion of the goods location carrier; tensioning devices H1 and H2 are arranged at the two ends of the track K respectively, and draglines I of the tensioning devices are respectively connected to the two ends of the lever liftable track push-pull machine F along the track K (it is also possible to use fluid transmission such as liquid pressure power, mechanical transmission such as gear chain, electric transmission such as linear motor, electromagnetic transmission, etc.), see FIG. 25. The lever liftable track push-pull machine F is dragged to move along the track K through the coordination of forward and backward pulling of the tensioning device H1 and pushing of the tensioning device H2 in the backward and forward direction, wherein the tensioning device H1 and the tensioning device H2 are arranged at the two ends of the track, to drives the goods carrier to move along the track B till the up-to N-2 rear advancing wheels of the goods carrier all accurately move to the vacant goods allocation position on the adjacent track B or the four (under the situation of double-track) rotatable beeline-shaped two-direction track section D on the track B; the goods carrier and the four (under the situation of double-track) rotatable beeline-shaped two-direction track section D corresponding to the up-to N-2 goods carrier are rotated to horizontal, supporting the moving goods carrier without falling. And subsequently, the lever G accurately rotates 90° reversely and is withdrawn out to be out of contact with the goods carrier. The lever liftable track push-pull machine can be provided with multiple, or other units can be supplemented to efficiently move the goods carrier.

When there is at least one goods allocation free and there is no goods carrier, each goods carrier can be moved to any goods allocation positions by transposition with adjacent vacant goods allocations.

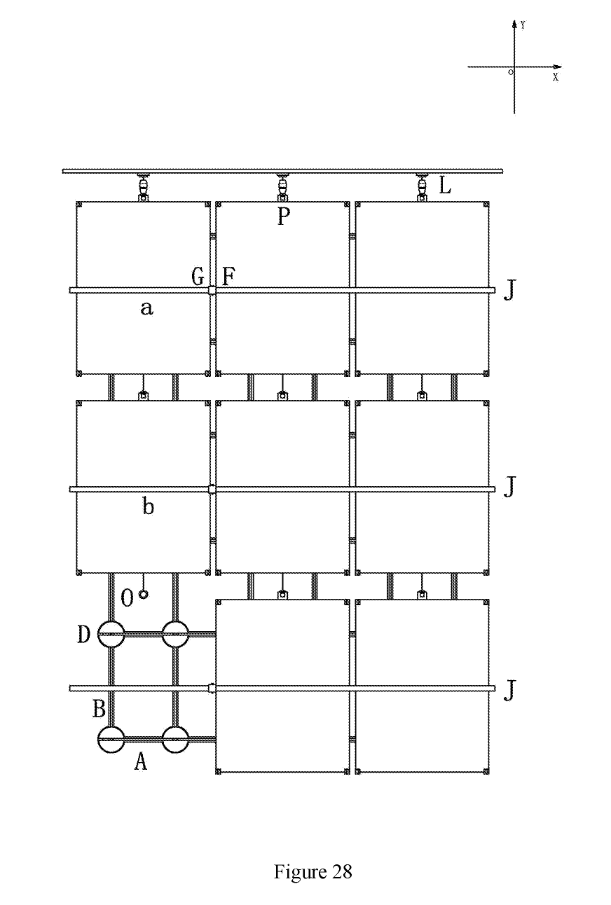

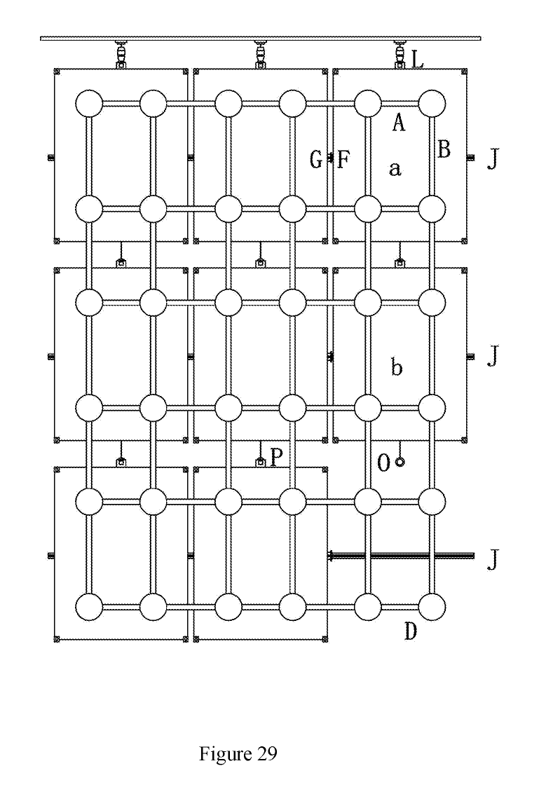

Embodiment 6: see FIGS. 24, 26, 28, 29, and 30. An X axis in a vertical rectangular plane coordinate system is vertical to a Y axis therein, N groups of discontinuous single track or double track A is disposed along the X axis, M groups of discontinuous single track or double track B is disposed along the Y axis, and a rotatable beeline-shaped two-direction track section D is arranged at each intersection of an extension line of the track A and an extension line of the track B; the advancing wheels matched with the track are arranged below the goods carrier; the rotatable beeline-shaped two-direction track section D combining into a complete communication track with the track A combines into a complete communication track with the track B after rotating 90°; the rotatable beeline-shaped two-direction track section D combining into a complete communication track with the track B gets back in position after reversely rotating 90° to combine a complete communication track with the track A.

The plane of the advancing wheels matched with the track arranged below the goods carrier is set to be parallel to the X and Y axes in the above-mentioned vertical rectangular plane coordinate system, see FIG. 23 (wherein V is the advancing wheels axis). When the plane of the advancing wheels matched with the track arranged below the goods carrier is set to be vertical to the X and Y axes in the above-mentioned vertical rectangular plane coordinate system, the cross-shaped four-direction rotatable track section D can also be used, see FIGS. 5, 10, and 20 (wherein V is the advancing wheels axis).

The rotatable beeline-shaped two-direction track section D is equipped with the motor, and under the drive of the motor, the rotatable beeline-shaped two-direction track section accurately rotates 90° or reversely rotates 90°; and therefore, the switch of a moving direction of the goods carrier between the track A and the track B is realized, and a moveable track passage in four directions, i.e. two directions of the track A and the track B respectively, is built.

The track J is arranged in front of the goods carrier opposite the track A in a way parallel to the track A, the lever liftable track push-pull machine F is arranged on the track J, and under the drive of the motor, the lever G accurately rotates and is extended to come into contact with the goods carrier; tensioning devices H1 and H2 are arranged at the two ends of the track J respectively, and draglines I of the tensioning devices are respectively connected to the two ends of the lever liftable track push-pull machine F along the track J; and the lever liftable track push-pull machine F is dragged to move along the track J through the coordination of forward and backward pulling of the tensioning device H1 and pushing of the tensioning device H2 in the backward and forward direction, wherein the tensioning device H1 and the tensioning device H2 are arranged at the two ends of the track (it is also possible to use fluid transmission such as liquid pressure power, mechanical transmission such as gear chain, electric transmission such as linear motor, electromagnetic transmission, etc.), to drives the goods carrier to move along the track A till the rear advancing wheels of the goods carrier accurately move to the four (under the situation of double-track) rotatable beeline-shaped two-direction track section D on the adjacent vacant goods allocations. And subsequently, the lever G accurately rotates 90° reversely and is ascended to be out of contact with the goods carrier. The lever liftable track push-pull machine can be provided with multiple, or other units can be supplemented to efficiently move the goods carrier.

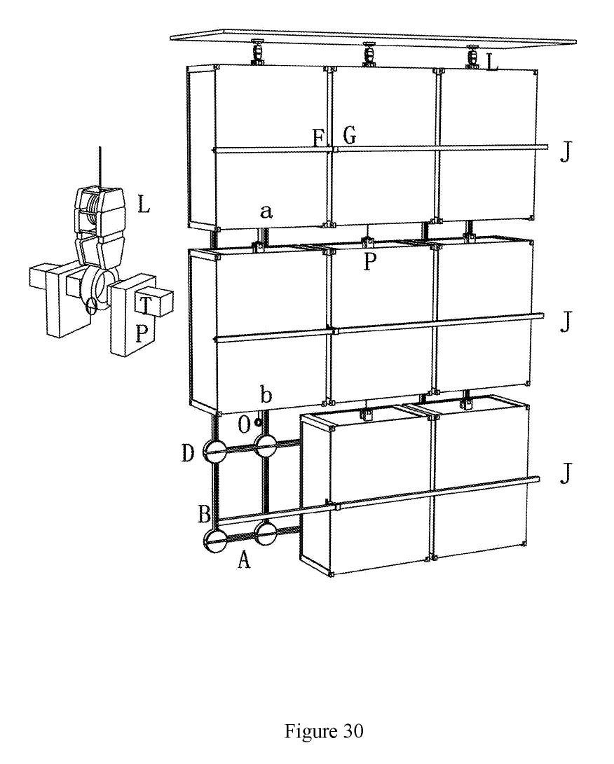

A pair-advancing hoisting and linking system (it is also possible to use fluid transmission such as liquid pressure power, mechanical transmission such as gear chain, electric transmission such as linear motor, electromagnetic transmission, etc.) is provided, see FIG. 30. A crane L is arranged at the top of each group of track B, a lifting ring O is arranged below the rope of the crane L, a pair-advancing hook P is arranged at the top of each goods carrier, and a lifting ring O is arranged at the bottom thereof; when the goods carrier b on a group of track B needs to be moved, the crane L puts down the rope and the lifting ring O; after being accurately seated, the two hook booms T of the pair-advancing hook P at the top of the goods carrier a closest to the crane L are inserted into the lifting ring O and locked. Among the goods carrier b and all the goods carriers above the goods carrier b and below the goods carrier a on the same track B, the two hook booms T of the top pair-advancing hook P move toward each other and inserted into the bottom lifting ring O of the goods carrier and locked. Accordingly, goods carrier a, goods carrier b and all the goods carriers on the same track B can be moved under the tension of the crane L, till the rear advancing wheels of all the moving goods carriers accurately move to the four (under the situation of double-track) rotatable beeline-shaped two-direction track section D on the adjacent vacant goods allocations. The rotatable beeline-shaped two-direction track section D of the rear portion of the moving goods carrier combines into a complete communication track with the track A after rotating 90°, supporting the moving goods carrier without falling. And subsequently, the two hook booms T of the pair-advancing hook P at the top of the goods carrier move in opposite directions respectively under the drive of the motor, and are separated from the upper goods carrier or the bottom lifting ring O of the crane L to unlock.

When there is at least one goods allocation free and there is no goods carrier, each goods carrier can be moved to any goods allocation positions by continuous transposition with adjacent vacant goods allocations.

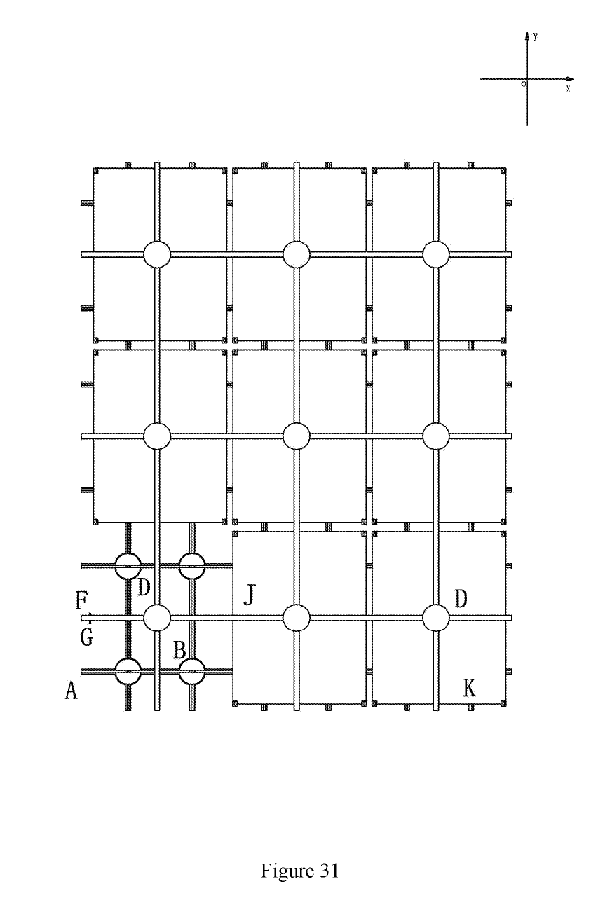

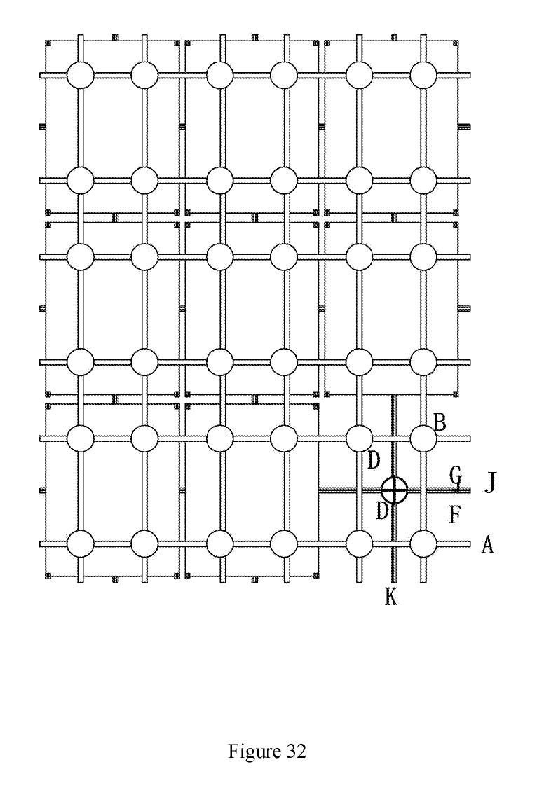

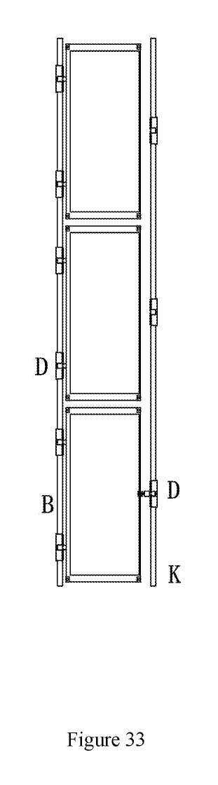

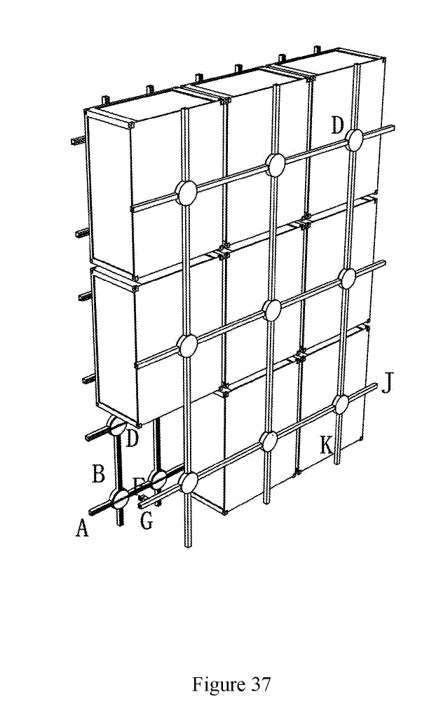

Embodiment 7: see FIGS. 31-34 and 37. An X axis in a vertical rectangular plane coordinate system is vertical to a Y axis therein, N groups of discontinuous single track or double track A is disposed along the X axis, M groups of discontinuous single track or double track B is disposed along the Y axis, and a rotatable beeline-shaped two-direction track section D is arranged at each intersection of an extension line of the track A and an extension line of the track B; the advancing wheels matched with the track are arranged below the goods carrier; the rotatable beeline-shaped two-direction track section D combining into a complete communication track with the track A combines into a complete communication track with the track B after rotating 90°; the rotatable beeline-shaped two-direction track section D combining into a complete communication track with the track B gets back in position after reversely rotating 90° to combine a complete communication track with the track A.

The plane of the advancing wheels matched with the track arranged below the goods carrier is set to be parallel to the X and Y axes in the above-mentioned vertical rectangular plane coordinate system, see FIG. 23 (wherein V is the advancing wheels axis). When the plane of the advancing wheels matched with the track arranged below the goods carrier is set to be vertical to the X and Y axes in the above-mentioned vertical rectangular plane coordinate system, the cross-shaped four-direction rotatable track section D can also be used, see FIGS. 5, 10, and 20 (wherein V is the advancing wheels axis).

The rotatable beeline-shaped two-direction track section D is equipped with the motor, and under the drive of the motor, the rotatable beeline-shaped two-direction track section accurately rotates 90° or reversely rotates 90°; and therefore, the switch of a moving direction of the goods carrier between the track A and the track B is realized, and a moveable track passage in four directions, i.e. two directions of the track A and the track B respectively, is built.

The tracks J and K are respectively arranged opposite the goods carrier in a way parallel to the tracks A and B, the track self-propelling lever liftable push-pull machine F is arranged on the tracks J and K, and under the drive of the motor, the lever G on the track self-propelling lever liftable push-pull machine F accurately rotates and is extended to hold on the bottom of the goods carrier or comes into contact with the side of the goods carrier; the lever G on the track self-propelling lever liftable push-pull machine F accurately rotates reversely and is retracted to be out of contact with the goods carrier. The track self-propelling lever liftable push-pull machine F has the power action device enabling the track self-propelling lever liftable push-pull machine F to move along the track J or K; when the lever G is extended, the track self-propelling lever liftable push-pull machine F moves to push the goods carrier to move along the track A or B, till the advancing wheels under the goods carrier accurately move to the four (under the situation of double-track) rotatable beeline-shaped two-direction track section D of the next goods allocation. The rotatable beeline-shaped two-direction track section D is rotated to horizontal, supporting the moving goods carrier without falling. The lever G system arranged at the track self-propelling lever liftable push-pull machines F can be rotated 90° in the plane parallel to the horizontal rectangular plane coordinate system (the plane where the X and Y axes are located), to meet the need that the lever G both can be extended to hold on the bottom of the goods carrier (when the goods carrier moves vertically along the track B), and can come into contact with the side of the goods carrier (when the goods carrier moves horizontally along the track A). The lever liftable track push-pull machine can be provided with multiple, or other units can be supplemented to efficiently move the goods carrier.

When there is at least one goods allocation free and there is no goods carrier, each goods carrier can be moved to any goods allocation positions by continuous transposition with adjacent vacant goods allocations.

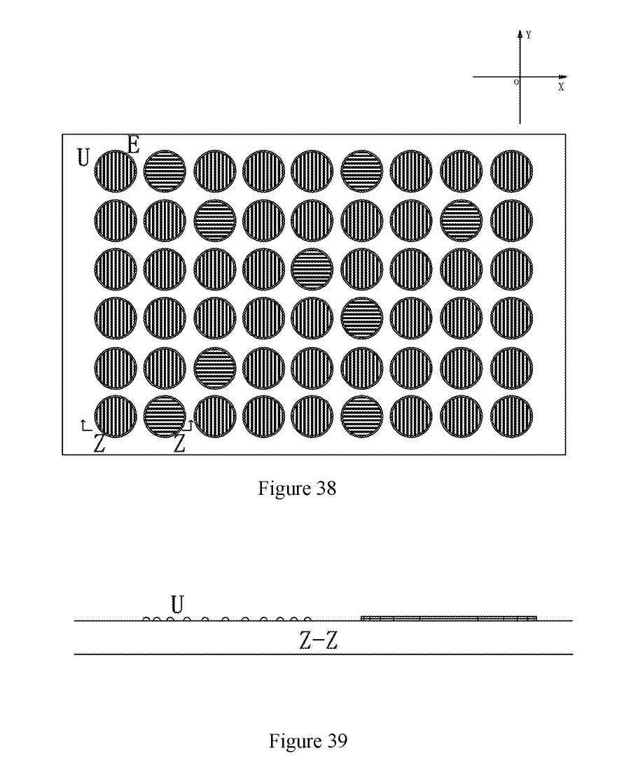

Embodiment 8: see FIGS. 38 and 39. A rotating platform E is arranged on each goods allocation, wherein a unit power roller conveyor or a unit power conveying belt U is arranged on the upper portion of the rotating platform E. The X axis in the horizontal rectangular plane coordinate system is vertical to the Y axis therein; the rotating platform E along the X axis is taken as an N line, and the rotating platform E along the Y axis is taken as an M column; a conveying direction is the Y axis after the unit power roller conveyor or the unit power conveying belt rotating platform in the X axis rotates 90°, and restores to the X axis after the unit power roller conveyor or the unit power conveying belt rotating platform reversely rotates 90°; and therefore, the switch of the moving direction of the unit power roller conveyor or the unit power conveying belt on the goods carrier transportation between the X axis and the Y axis is realized, with two positive and negative directions of the unit power roller or the unit power conveying belt conveyor, and a unit power roller conveyor or the unit power conveying belt on the goods carrier transportation passage in four directions, i.e. two directions of the X axis and the Y axis respectively, is built.

When there is at least one goods allocation free and there is no goods carrier, the unit power roller conveyor or the unit power conveying belt can transport the goods carrier to the adjacent unit power roller conveyor or the unit power conveying belt whose goods allocation is vacant (without a goods carrier), each goods carrier can be moved to any goods allocation positions by continuous transposition with adjacent vacant goods allocations.

Embodiment 9: the system arrangement is similar to that of Embodiment 1. The X axis in the horizontal rectangular plane coordinate system is vertical to the Y axis therein, N groups of single track or double track A is disposed along the X axis, M groups of single track or double track B is disposed along the Y axis.

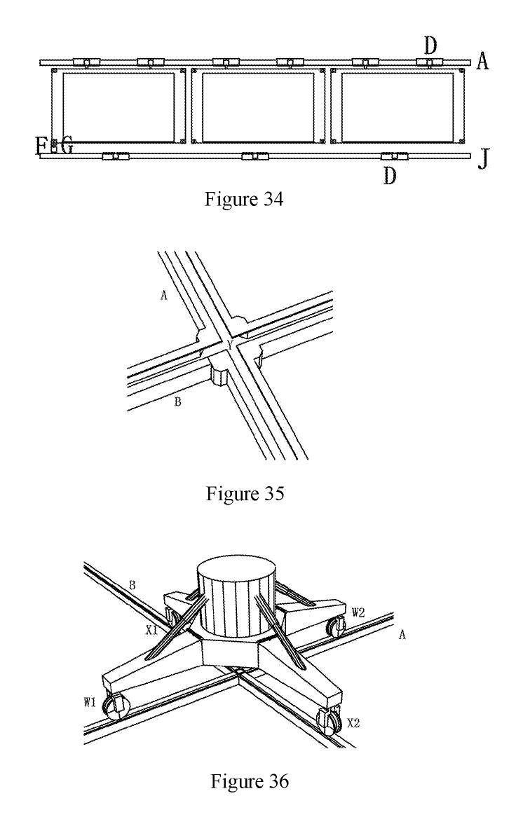

The goods carrier is equipped with the four-direction lifting advancing wheels, see FIG. 36. When the goods carrier is to be advanced on the track A, the advancing wheels W1 and W2 of the four-direction lifting advancing wheels of the goods carrier in the track A direction are descended to come into contact with the track A, and subsequently, the advancing wheels X1 and X2 in the track B direction are ascended to be out of contact with the track B. When the goods carrier is to be advanced on the track B, the advancing wheels X1 and X2 of the four-direction lifting advancing wheels of the goods carrier in the track B are descended to come into contact with the track B, and subsequently, the advancing wheels W1 and W2 in the track A are ascended to be out of contact with the track A. Accordingly, at each intersection of the track A and the track B, the switch of a moving direction of the goods carrier between the track A and the track B is realized, and a moveable track passage in four directions, i.e. two directions of the track A and the track B respectively, is built.

A track J is arranged under the track A in a way parallel to the track A; lever liftable track push-pull machines F1 and F2 which are connected together are arranged on the track J (it is also possible to use fluid transmission such as liquid pressure power, mechanical transmission such as gear chain, electric transmission such as linear motor, electromagnetic transmission, etc.).

A track K is arranged above the goods carrier on the track B in a way parallel to the track B; the lever liftable track push-pull machine F is arranged on the track K (it is also possible to use fluid transmission such as liquid pressure power, mechanical transmission such as gear chain, electric transmission such as linear motor, electromagnetic transmission, etc.).

When there is at least one goods allocation free and there is no goods carrier, each goods carrier can be moved to any goods allocation positions by transposition with adjacent vacant goods allocations.

This plane storage and transportation unit of a stereoscopic warehouse with four-direction movable goods allocations is used as the basic component of the horizontal or vertical storage and transportation plane of the stereoscopic warehouse or parking garage, and the vertical or horizontal storage and transportation channel vertical to its working plane can be supplemented; for instance, the plane storage and transportation unit of a stereoscopic warehouse with four-direction movable goods allocations is used as the basic component, namely, the storage and transportation layer, of horizontal or vertical storage and transportation plane of the stereoscopic warehouse or parking garage, and if the lifting device is supplemented in the vertical direction, numerous storage and transportation layers can be assembled into a complete stereoscopic warehouse or parking garage. Basically, all available space can be set into the goods (vehicles) position, and the space utilization rate is high. The advantages in ship loading, old building renovation and underground parking lot construction are obvious. It is also suitable for intelligent control; the storage location of the goods (vehicles) is controllable, the positioning is good, the access efficiency is high, and the anti-theft performance is good. For the always changing access needs, the location of the goods (vehicles) can be adjusted at any time to achieve goods (vehicles) access at the fastest speed. For example, in the “Double 11”, a day when Chinese people go on massive Internet shopping sprees because many online stores offer huge discounts on this day, the shipment rate of a certain product increases sharply during a certain period of time; the intelligent control system can control the proper concentration of such goods in the whole warehouse to the pick-up window, which will greatly reduce the workload and improve the shipping efficiency, and this is difficult to be achieved in the traditional stereoscopic warehouse system. Another example is that: consumers go to a large mall for shopping and entertainment, while the car is parked in Area A and the consumption ends in Area F, the two places are far apart, and customers have to get the car at where the car is parked in the prior parking lots. The stereoscopic parking garage composed of this plane storage and transportation unit of a stereoscopic warehouse with four-direction movable goods allocations can be provided with one or several access entrances as needed, and the vehicles allocation is movable, hence, off-site getting the car nearby or even the car moves in the same direction as the owner moves can be completely realized.

This plane storage and transportation unit of a stereoscopic warehouse with four-direction movable goods allocations has broad application prospects in library collections, archives archiving, collection of museum collections, and storage of the goods. It not only has the similar advantages described above. If the functions such as temperature and moisture control, prevention of biological damage, fire prevention and theft are to be achieved in the traditional warehousing, it is basically aimed at the building envelope structure or the separation structure of the building space, because the entire storage system requires too many access passages, and it is difficult to achieve the centralized and sealed storage. The invention can be only provided with one or a few controllable access channels to store the stored goods in a centralized manner, and to reduce the space of the environment control, so that a more optimized storage environment can be provided under the premise of being economical, effective and controllable. At the same time, because the environmental space is controlled to be compact, the cost for environmental control and preservation is lower, the energy consumption is less, and it is more energy-saving and environmental-friendly. With the supplementary of the intelligent system, it is extremely convenient to record the date, content, storage location and other information for the electronic file of the stored goods; it is extremely convenient to search information and access goods, and it is easier to be implemented and more efficient in automated management of collection status monitoring, environmental status monitoring, and accident alarms.

Due to the heavy dust in northern China, the cabinets, bookcases, lockers, sundries and other furniture used in the traditional household storage are poor in dustproof performance; this plane storage and transportation unit of a stereoscopic warehouse with four-direction movable goods allocations can be used as the storage cabinet under the cabinet or the tatami, and it can be completely sealed and has good dustproof performance. In southern China, the environment is humid and the biological damage is serious. This plane storage and transportation unit of a stereoscopic warehouse with four-direction movable goods allocations can be used as the storage space and can be completely sealed; the temperature and humidity can be controlled to prevent mildew; measures to kill pests can be used in the space without worrying about affecting human health. The prior architectural concrete frames and steel structural frames are becoming more and more widely used, and has become the mainstream, which brings an issue that whether the space occupied by the partition wall in the room can be changed into the storage space. And at the same time, it has the function of storage and separation, and the space utilization rate is higher, which makes the room neater. The idea is good. However, the problem is that the current furniture has two problems as a partition wall: the open cabinets without cabinet doors are not soundproof, and all cabinets for all purposes are not suitable to be set as non-door structure; while when the cabinet doors are provided, it is unsightly that the cabinet doors are everywhere; even if there is a gap, it is not beautiful for aesthetic purposes, and the overall decoration style of the room is not easy to be coordinated; moreover, if the cabinet doors are provided, other furniture cannot be placed in front of the cabinet wall, otherwise the furniture needs to be moved and the space utilization rate is low. This plane storage and transportation unit of a stereoscopic warehouse with four-direction movable goods allocations can be used as the storage space, and only a small opening for accessing goods is needed in an unobtrusive position, such as behind a door; and when it is used as the bookcase, even an opening of the size of the book section is required. Accordingly, the walls on both sides of the cabinet can be integrated, the wall is seamless, and it is easy to be coordinated with the overall decoration style and to handle sound insulation problems, the structural strength is higher, the anti-theft effect is good, and the room is neater and more orderly. Because the upper space of the room is utilized, the space utilization is more efficient and more goods can be stored. Foremost, with the supplementary of the intelligent system, the electronic file of the goods can be created when storing the goods to record the date, content, storage location and other information, which can be searched at any time; with one click for accessing goods, there will be no troubles to find goods, which meet the needs for smart home.

The technology can also be applied to display museum collections, artworks, jewelry, clothing and other display systems. The exhibition arrangement and removal are convenient and fast, and the display position of the exhibits can be changed during the exhibition process.

1. A plane storage and transportation unit of a stereoscopic warehouse with four-direction movable goods allocations, wherein: an X axis in a spatial rectangular plane coordinate system is vertical to a Y axis therein, N groups of single track or double track A is disposed along the X axis, and M groups of single track or double track B is disposed along the Y axis; a goods carrier or a device for moving the goods carrier is run on the tracks A and B; the goods carrier or the device for moving the goods carrier is equipped with an advancing system matched with the track, and moves by depending on a power system thereof or under the action of an external power system; at each intersection of the track A and the track B, the track and the advancing system of the goods carrier or the device for moving the goods carrier enable an advancing direction of the goods carrier to be transformed between the track A and the track B; or the goods carrier is combined with the device for moving the goods carrier in the system, and a unit power roller conveyor or a power conveyor belt which is tightly provided and has a rotation direction transfers and moves the goods.

2. The plane storage and transportation unit of the stereoscopic warehouse with four-direction movable goods allocations according to claim 1, wherein: the X axis in the spatial rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable or beeline-shaped two-direction track section D is arranged at each intersection of an extension line of the track A and an extension line of the track B; the cross-shaped four-direction rotatable or beeline-shaped two-direction track section D combining into a complete communication track with the track A combines into a complete communication track with the track B after rotating 90°, and gets back in position after reversely rotating 90° to combine into a complete communication track with the track B; the goods carrier or the device for moving the goods carrier is run on the tracks A and B; advancing wheels matched with the track are arranged under the goods carrier or the device for moving the goods carrier, and are driven by the cross-shaped four-direction rotatable or beeline-shaped two-direction track section D for rotation; and the goods carrier moves by depending on the power system thereof or under the action of the external power system.

3. The plane storage and transportation unit of the stereoscopic warehouse with four-direction movable goods allocations according to claim 1, wherein: the X axis in the spatial rectangular plane coordinate system is vertical to the Y axis therein, N groups of discontinuous single track or double track A is disposed along the X axis, M groups of discontinuous single track or double track B is disposed along the Y axis, and a cross-shaped four-direction rotatable or beeline-shaped two-direction track section D is arranged at each intersection of an extension line of the track A and an extension line of the track B; the advancing wheels matched with the track are arranged below the goods carrier; the cross-shaped four-direction rotatable or beeline-shaped two-direction track section D combining into a complete communication track with the track A combines into a complete communication track with the track B after rotating 90°, and meanwhile, drives the advancing wheels of the goods carrier thereon for rotating 90°; the cross-shaped four-direction rotatable or beeline-shaped two-direction track section D combining into a complete communication track with the track B gets back in position after reversely rotating 90° to combine into a complete communication track with the track A, and meanwhile, drives the advancing wheels of the goods carrier thereon for reversely rotating 90°; a track J is arranged under the track A in a way parallel to the track A; lever liftable track push-pull machines F1 and F2 which are connected together are arranged on the track J, and under the drive of a motor, levers G1 and G2 on F1 and F2 accurately rotate 90° or reversely rotate 90° successively, and the levers G1 and G2 are extended or withdrawn successively to realize contact with the goods carrier or release the contact; tensioning devices H1 and H2 are arranged at the two ends of the track J respectively, and draglines I of the tensioning devices are respectively connected to the two ends of the lever liftable track push-pull machines along the track J; a track K is arranged above the goods carrier on the track B in a way parallel to the track B; the lever liftable track push-pull machines are arranged on the track K, and under the drive of the motor, the levers accurately rotate 90° and are extended to come into contact with the goods carrier; the tensioning devices are respectively arranged at the two ends of the track K, and the draglines of the tensioning devices are respectively connected to the two ends of the lever liftable track push-pull machines along the track K; or, the tracks J and K are arranged above the goods carrier and respectively parallel to the tracks A and B, a track self-propelling lever liftable push-pull machine is arranged on the tracks J and K and has a power action device which moves along the track J or K.

4. The plane storage and transportation unit of the stereoscopic warehouse with four-direction movable goods allocations according to claim 1, wherein: the X axis in the spatial rectangular plane coordinate system is vertical to the Y axis therein, N groups of discontinuous single track or double track A is disposed along the X axis, M groups of discontinuous single track or double track B is disposed along the Y axis, and a four-direction rotatable or beeline-shaped two-direction track section D is arranged at each intersection of an extension line of the track A and an extension line of the track B; the cross-shaped four-direction rotatable or beeline-shaped two-direction track section D combining into a complete communication track with the track A combines into a complete communication track with the track B after rotating 90°; the cross-shaped four-direction rotatable or beeline-shaped two-direction track section D combining into a complete communication track with the track B gets back in position after reversely rotating 90° to combine into a complete communication track with the track A; and a self-propelled transfer robot advancing along the track is arranged on the track below the goods location carrier; or a self-propelled lifting robot advancing along the track is arranged on the track above the goods location carrier.

5. The plane storage and transportation unit of the stereoscopic warehouse with four-direction movable goods allocations according to claim 1, wherein: an X axis in a vertical rectangular plane coordinate system is vertical to a Y axis therein, N groups of discontinuous single track or double track A is disposed along the X axis, M groups of discontinuous single track or double track B is disposed along the Y axis, and a cross-shaped four-direction rotatable or beeline-shaped two-direction track section D is arranged at each intersection of an extension line of the track A and an extension line of the track B; the advancing wheels matched with the track are arranged below the goods carrier; the cross-shaped four-direction rotatable or beeline-shaped two-direction track section D combining into a complete communication track with the track A combines into a complete communication track with the track B after rotating 90°; the cross-shaped four-direction rotatable or beeline-shaped two-direction track section D combining into a complete communication track with the track B gets back in position after reversely rotating 90° to combine a complete communication track with the track A; the track J is arranged in front of the goods carrier opposite the track A in a way parallel to the track A, the lever liftable track push-pull machine is arranged on the track J, and under the drive of the motor, the lever accurately rotates and is extended to come into contact with the goods carrier; the tensioning devices are arranged at the two ends of the track J respectively, and the draglines of the tensioning devices are respectively connected to the two ends of the lever liftable track push-pull machine along the track J; the track K is arranged at the side of the track B in a way parallel to the track B, the lever liftable track push-pull machine is arranged on the track K, and under the drive of the motor, the lever accurately rotates and is extended to be inserted into the lower part of the goods carrier; tensioning devices are respectively arranged at the two ends of the track K, and the draglines of the tensioning devices are respectively connected to the two ends of the lever liftable track push-pull machine along the track K; or, a crane is arranged at the top of each group of track B, a lifting ring is arranged below a crane rope, a pair-advancing hook is arranged at the top of each goods carrier, and a lifting ring is arranged at the bottom thereof; or, the tracks J and K are respectively arranged opposite the goods carrier in a way parallel to the tracks A and B, the track self-propelling lever liftable push-pull machine is arranged on the tracks J and K, and has the power action device enabling the track self-propelling lever liftable push-pull machine to move along the track J or K.

6. The plane storage and transportation unit of the stereoscopic warehouse with four-direction movable goods allocations according to claim 1, wherein: a unit power roller conveyor or a unit power conveying belt rotating platform is arranged on each goods allocation, the X axis in the spatial rectangular plane coordinate system is vertical to the Y axis therein, the unit power roller conveyor or the unit power conveying belt rotating platform along the X axis is taken as an N line, and the unit power roller conveyor or the unit power conveying belt rotating platform along the Y axis is taken as an M column; a conveying direction is the Y axis after the unit power roller conveyor or the unit power conveying belt rotating platform in the X axis rotates 90°, and restores to the X axis after the unit power roller conveyor or the unit power conveying belt rotating platform reversely rotates 90°; and the unit power roller conveyor or the unit power conveying belt rotating platform has forward and backward conveying directions.

7. The plane storage and transportation unit of the stereoscopic warehouse with four-direction movable goods allocations according to claim 1, wherein: the cross-shaped four-direction rotatable or beeline-shaped two-direction track section is set into a crisscross shape or beeline shape, the motor is arranged below the track, and under the drive of the motor, the cross-shaped four-direction rotatable or beeline-shaped two-direction track section accurately rotates 90° or reversely rotates 90°, and drives the advancing wheels of the goods carrier or the transfer robot, the lifting robot, the track lever liftable push-pull machine and the track self-propelling lever liftable push-pull machine to rotate; or, chambers for rotating the advancing wheels of the goods carrier or the transfer robot, the lifting robot, the track lever liftable push-pull machine and the track self-propelling lever liftable push-pull machine are arranged in the cross-shaped four-direction track section formed by track intersection.

8. The plane storage and transportation unit of the stereoscopic warehouse with four-direction movable goods allocations according to claim 1, wherein: the lever liftable track push-pull machine is equipped with the motor, and under the drive of the motor, the lever accurately rotates or reversely rotates, and comes into contact with the goods carrier and release the contact with the same respectively; the tensioning devices are arranged at the two ends of the track respectively, the draglines of the tensioning devices are respectively connected to the two ends of the lever liftable track push-pull machine along the track, and the lever liftable track push-pull machine is dragged to move along the track through the coordination of forward and backward pulling of the tensioning device 1 and pushing of the tensioning device 2 in the backward and forward direction, wherein the tensioning device 1 and the tensioning device 2 are arranged at the two ends of the track; or the lever liftable track push-pull machine moves in reliance on fluid power, mechanical power, electric power and electromagnetic power; or, the lever liftable track push-pull machine is equipped with the power action device, which has a self-action function and is called as the track self-propelling lever liftable push-pull machine; and the lever liftable track push-pull machine rotates under the drive of the motor, to meet the needs of different push-pull angles.

9. The plane storage and transportation unit of the stereoscopic warehouse with four-direction movable goods allocations according to claim 1, wherein: the pair-advancing hook is equipped with a pair of horizontal booms arranged oppositely, and the pair of booms moves oppositely or away under the drive of the motor, to be respectively inserted into or separated from the lifting ring to keep the locking and unlocking with the lifting ring.

10. The plane storage and transportation unit of the stereoscopic warehouse with four-direction movable goods allocations according to claim 1, wherein: the goods carrier or the device for moving the goods carrier is equipped with four-direction lifting advancing wheels, and when the goods carrier is to be advanced on the track A, the advancing wheels W1 and W2 of the four-direction lifting advancing wheels of the goods carrier in the track A direction are descended to come into contact with the track A, and subsequently, the advancing wheels X1 and X2 in the track B direction are ascended to be out of contact with the track B; when the goods carrier is to be advanced on the track B, the advancing wheels X1 and X2 of the four-direction lifting advancing wheels of the goods carrier in the track B are descended to come into contact with the track B, and subsequently, the advancing wheels W1 and W2 in the track A are ascended to be out of contact with the track A; and therefore, the switch of a moving direction of the goods carrier between the track A and the track B is realized, and a moveable track passage in four directions, i.e. two directions of the track A and the track B respectively, is built.
